(19) United States
(12) Patent Application Publication
(10) Pub. No.: US 2026/0239167 A1
(43) Pub. Date: Aug. 13, 2026

(54) NETWORK COORDINATION FOR MULTI-HOP RELAYS

(71) Applicant: QUALCOMM Incorporated, San Diego, CA (US)

(72) Inventors: Shankar KRISHNAN, San Diego, CA (US); Jianhua LIU, Beijing (CN); Hong CHENG, Basking Ridge, NJ (US)

(21) Appl. No.: 19/470,730

(22) PCT Filed: May 10, 2023
(86) PCT No.: PCT/CN2023/093182

§ 371 Date: Sep. 29, 2025

(51) Int. Cl. H04W 40/22

(52) U.S. Cl. CPC H04W 40/22

(57) ABSTRACT

Methods, systems, and devices for wireless communication are described. Network entities may coordinate to support mobility of multi-hop relay configurations. A network entity may receive a coordination information message for a first user equipment (UE). The coordination information message may include one or more parameters for a multi-hop relay operation associated with multiple UEs including the first UE. The network entity may communicate with the first UE based on receiving the coordination information message. The network entity may communicate with at least a second UE of the multiple UEs via the first UE according to the multi-hop relay operation and the coordination information message.

### CROSS REFERENCE

This application is a 371 National Stage of PCT Application No. PCT/CN2023/093182, filed on May 10, 2023, entitled “NETWORK COORDINATION FOR MULTI-HOP RELAYS”, and assigned to the assignee hereof. The disclosure of the prior application is considered part of and is incorporated by reference into this patent application.

### FIELD OF TECHNOLOGY

The following relates to wireless communication, including network coordination for multi-hop relays.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support network coordination for multi-hop relays. For example, the described techniques enable coordination between network entities to support mobility of multi-hop relay configurations associated with one or more UEs (e.g., a remote UE, one or more intermediate relay UEs, and a donor relay UE). For example, a first network entity may support a multi-hop relay configuration with the one or more UEs. A first UE (e.g., the donor relay UE) of the one or more UEs may be mobile, and may switch from the first network entity to a second network entity, and the second network entity may receive a coordination information message (e.g., from the first network entity). The coordination information message may include one or more parameters for the multi-hop relay operation associated with the one or more UEs. The second network entity may communicate with the first UE based on receiving the coordination information message. Further, the second network entity may communicate with a second UE (e.g., the remote UE) of the one or more UEs via the first UE (e.g., and the one or more intermediate relay UEs) according to the multi-hop relay configuration and the coordination information message (e.g., the second network entity may utilize the multi-hop relay configuration to communicate with the remote UE based on the coordination information message, instead of establishing a new multi-hop relay configuration).

A method for wireless communications at a network entity is described. The method may include receiving a coordination information message for a first user equipment (UE), the coordination information message including one or more parameters for a multi-hop relay operation associated with a set of multiple UEs including the first UE, communicating with the first UE based on receiving the coordination information message, and communicating with at least a second UE of the set of multiple UEs via the first UE according to the multi-hop relay operation and the coordination information message.

An apparatus for wireless communications at a network entity is described is described. The apparatus may include a processor, memory coupled with the processor, and instructions stored in the memory. The instructions may be executable by the processor to cause the apparatus to receive a coordination information message for a first UE, the coordination information message including one or more parameters for a multi-hop relay operation associated with a set of multiple UEs including the first UE, communicate with the first UE based on receiving the coordination information message, and communicate with at least a second UE of the set of multiple UEs via the first UE according to the multi-hop relay operation and the coordination information message.

Another apparatus for wireless communications at a network entity is described. The apparatus may include means for receiving a coordination information message for a first UE, the coordination information message including one or more parameters for a multi-hop relay operation associated with a set of multiple UEs including the first UE, means for communicating with the first UE based on receiving the coordination information message, and means for communicating with at least a second UE of the set of multiple UEs via the first UE according to the multi-hop relay operation and the coordination information message.

A non-transitory computer-readable medium storing code is described. The code may include instructions executable by a processor to receive a coordination information message for a first UE, the coordination information message including one or more parameters for a multi-hop relay operation associated with a set of multiple UEs including the first UE, communicate with the first UE based on receiving the coordination information message, and communicate with at least a second UE of the set of multiple UEs via the first UE according to the multi-hop relay operation and the coordination information message.

Some examples of the method, apparatuses, and non-transitory computer-readable medium described herein may further include operations, features, means, or instructions for receiving, via the one or more parameters of the coordination information message, a multi-hop indication, a multi-hop route identifier, a multi-hop relay count, or any combination thereof.

Some examples of the method, apparatuses, and non-transitory computer-readable medium described herein may further include operations, features, means, or instructions for receiving, via the one or more parameters of the coordination information message, a proximity service (ProSe) user information identifier of the second UE, an identifier of the first UE, or any combination thereof.

Some examples of the method, apparatuses, and non-transitory computer-readable medium described herein may further include operations, features, means, or instructions for receiving, via the one or more parameters of the coordination information message, a first sidelink radio link control (RLC) channel configuration for each end-to-end (E2E) signal radio bearer (SRB) of a set of multiple E2E SRBs associated with the set of multiple UEs, a second sidelink RLC channel configuration for each E2E data radio bearer (DRB) of a set of multiple E2E DRBs associated with the set of multiple UEs, or both.

Some examples of the method, apparatuses, and non-transitory computer-readable medium described herein may further include operations, features, means, or instructions for signaling an indication of the first sidelink RLC channel configuration, the second sidelink RLC channel configuration, or both as part of a UE context setup procedure or a UE context modification procedure.

Some examples of the method, apparatuses, and non-transitory computer-readable medium described herein may further include operations, features, means, or instructions for receiving the coordination information message via a backhaul signaling message during a handover procedure between the network entity and another network entity.

Some examples of the method, apparatuses, and non-transitory computer-readable medium described herein may further include operations, features, means, or instructions for receiving the coordination information message via a backhaul signaling message during a UE context retrieval procedure, a UE context setup procedure, a UE context modification procedure, or any combination thereof.

Some examples of the method, apparatuses, and non-transitory computer-readable medium described herein may further include operations, features, means, or instructions for receiving, via the coordination information message, an authorization message that indicates that another network entity supports access for the multi-hop relay operation.

In some examples of the method, apparatuses, and non-transitory computer-readable medium described herein, the authorization message corresponds to a layer two relay authorization, a layer three relay authorization, a UE-to-network (U2N) relay authorization, and a UE-to-UE (U2U) authorization.

In some examples of the method, apparatuses, and non-transitory computer-readable medium described herein, the authorization message includes a first authorization for a layer two relay authorization, a second authorization for a layer three relay authorization, a third authorization including a U2N relay authorization, a fourth authorization including a U2U authorization, or any combination thereof.

In some examples of the method, apparatuses, and non-transitory computer-readable medium described herein, receiving the coordination information message may include operations, features, means, or instructions for receiving the coordination information message from another network entity, where the network entity includes a distributed unit (DU) network entity and the other network entity includes a central unit (CU) network entity.

A method is described. The method may include communicating with a first UE based on one or more parameters for a multi-hop relay operation associated with a set of multiple UEs including the first UE, communicating with at least a second UE of the set of multiple UEs via the first UE according to the one or more parameters for the multi-hop relay operation associated with the set of multiple UEs, and transmitting a coordination information message for the first UE, the coordination information message including the one or more parameters for the multi-hop relay operation associated with the set of multiple UEs including the first UE.

An apparatus is described. The apparatus may include a processor, memory coupled with the processor, and instructions stored in the memory. The instructions may be executable by the processor to cause the apparatus to communicate with a first UE based on one or more parameters for a multi-hop relay operation associated with a set of multiple UEs including the first UE, communicate with at least a second UE of the set of multiple UEs via the first UE according to the one or more parameters for the multi-hop relay operation associated with the set of multiple UEs, and transmit a coordination information message for the first UE, the coordination information message including the one or more parameters for the multi-hop relay operation associated with the set of multiple UEs including the first UE.

Another apparatus is described. The apparatus may include means for communicating with a first UE based on one or more parameters for a multi-hop relay operation associated with a set of multiple UEs including the first UE, means for communicating with at least a second UE of the set of multiple UEs via the first UE according to the one or more parameters for the multi-hop relay operation associated with the set of multiple UEs, and means for transmitting a coordination information message for the first UE, the coordination information message including the one or more parameters for the multi-hop relay operation associated with the set of multiple UEs including the first UE.

A non-transitory computer-readable medium storing code is described. The code may include instructions executable by a processor to communicate with a first UE based on one or more parameters for a multi-hop relay operation associated with a set of multiple UEs including the first UE, communicate with at least a second UE of the set of multiple UEs via the first UE according to the one or more parameters for the multi-hop relay operation associated with the set of multiple UEs, and transmit a coordination information message for the first UE, the coordination information message including the one or more parameters for the multi-hop relay operation associated with the set of multiple UEs including the first UE.

Some examples of the method, apparatuses, and non-transitory computer-readable medium described herein may further include operations, features, means, or instructions for transmitting, via the one or more parameters of the coordination information message, a multi-hop indication, a multi-hop route identifier, a multi-hop relay count, or any combination thereof.

Some examples of the method, apparatuses, and non-transitory computer-readable medium described herein may further include operations, features, means, or instructions for transmitting, via the one or more parameters of the coordination information message, a proximity service user information identifier of the second UE, an identifier of the first UE, or any combination thereof.

Some examples of the method, apparatuses, and non-transitory computer-readable medium described herein may further include operations, features, means, or instructions for transmitting, via the one or more parameters of the coordination information message, a first sidelink RLC channel configuration for each E2E SRB of a set of multiple E2E SRBs associated with the set of multiple UEs, a second sidelink RLC channel configuration for each E2E DRB of a set of multiple E2E DRBs associated with the set of multiple UEs, or both.

Some examples of the method, apparatuses, and non-transitory computer-readable medium described herein may further include operations, features, means, or instructions for signaling an indication of the first sidelink RLC channel configuration, the second sidelink RLC channel configuration, or both as part of a UE context setup procedure or a UE context modification procedure.

Some examples of the method, apparatuses, and non-transitory computer-readable medium described herein may further include operations, features, means, or instructions for transmitting the coordination information message via a backhaul signaling message during a handover procedure between the network entity and another network entity.

Some examples of the method, apparatuses, and non-transitory computer-readable medium described herein may further include operations, features, means, or instructions for transmitting the coordination information message via a backhaul signaling message during a UE context retrieval procedure, a UE context setup procedure, a UE context modification procedure, or any combination thereof.

Some examples of the method, apparatuses, and non-transitory computer-readable medium described herein may further include operations, features, means, or instructions for receiving, from another network entity, an authorization message that indicates that the network entity may be authorized to allow access for the multi-hop relay operation, where communicating with the second UE according to the one or more parameters for the multi-hop relay operation may be based on the authorization message and transmitting, via the coordination information message, the authorization message.

Some examples of the method, apparatuses, and non-transitory computer-readable medium described herein may further include operations, features, means, or instructions for transmitting, via the coordination information message, an authorization message that indicates that the network entity supports access for the multi-hop relay operation.

In some examples of the method, apparatuses, and non-transitory computer-readable medium described herein, the authorization message corresponds to a layer two relay authorization, a layer three relay authorization, a U2N relay authorization, and a U2U authorization.

In some examples of the method, apparatuses, and non-transitory computer-readable medium described herein, the authorization message includes a first authorization for a layer two relay authorization, a second authorization for a layer three relay authorization, a third authorization including a U2N relay authorization, a fourth authorization including a U2U authorization, or any combination thereof.

In some examples of the method, apparatuses, and non-transitory computer-readable medium described herein, transmitting the coordination information message may include operations, features, means, or instructions for transmitting the coordination information message to another network entity, where the other network entity includes a DU network entity and the network entity includes a CU network entity.

### BRIEF DESCRIPTION OF THE DRAWINGS

FIGS. 1 and 2 show examples of wireless communications systems that support network coordination for multi-hop relays in accordance with one or more aspects of the present disclosure.

FIGS. 3 and 4 show examples of process flows that support network coordination for multi-hop relays in accordance with one or more aspects of the present disclosure.

FIGS. 5 and 6 show block diagrams of devices that support network coordination for multi-hop relays in accordance with one or more aspects of the present disclosure.

FIG. 7 shows a block diagram of a communications manager that supports network coordination for multi-hop relays in accordance with one or more aspects of the present disclosure.

FIG. 8 shows a diagram of a system including a device that supports network coordination for multi-hop relays in accordance with one or more aspects of the present disclosure.

FIGS. 9 through 14 show flowcharts illustrating methods that support network coordination for multi-hop relays in accordance with one or more aspects of the present disclosure.

### DETAILED DESCRIPTION

Wireless communication systems may support relay communication configurations. In some cases, a first user equipment (UE) may be unable to directly communicate with a network entity (e.g., the first UE may be out of coverage or otherwise obstructed) but may be able to communicate with other UEs, where at least one of the other UEs is connected to the network entity (e.g., a network entity authorized for relay communications). For instance, the first UE (e.g., a remote UE) may communicate with a first network entity via a second UE (e.g., a donor relay UE) that is connected to the first network entity. The first UE may be directly connected to the second UE (e.g., a single-hop relay configuration) or may be connected to the second UE via a series of one or more other UEs (e.g., intermediate relay UEs) with respective relay links (e.g., a multi-hop relay configuration). The second UE and the first network entity may exchange various coordination parameters to establish the relay configuration (e.g., the multi-hop relay configuration) between the first UE and the first network entity.

For instance, the second UE may and the first network entity may exchange coordination parameters such as a multi-hop indication, a relay hop count, a route identifier (ID), an ID of the first UE, an ID of the second UE, a per-hop PC5 radio link control (RLC) channel (CH) configuration for end-to-end (E2E) signal radio bearers (SRBs) or data radio bearers (DRBs), and the like. In some cases, the second UE may move (e.g., and may perform a handover procedure) from the first network entity to a second network entity (e.g., from a first gNB to a second gNB, or from a first DU to a second DU associated with a same CU) as part of a mobility event (e.g., based on movement of the UE, or to improve communication quality, among other examples). However, in such cases, the second network entity may not have a context (e.g., may not have access to the coordination parameters of the multi-hop relay configuration, relay authorization information) of the relay configuration between the first network entity and the first UE, which may increase latency and cause disruption in mobility procedures (e.g., due to the second network entity reperforming establishment of the relay configuration).

According to aspects described herein, network entities may coordinate with each other to support mobility and authorization of multi-hop relay communications. In some examples, based on a UE mobility event from the first network entity (e.g., an old gNB) to the second network entity (e.g., a new gNB, or a new gNB-DU)), the first network entity may transmit more or more parameters associated with the multi-hop relay configuration of the UEs such as a multi-hop indication, a route ID, a proximity service (ProSe) user info ID for the remote UE, donor relay UE information, a relay hop count, a per-hop PC5 RLC CH configuration for E2E SRBs, a per-hop PC5 RLC CH configuration for E2E DRBs, among other parameters. Additionally, or alternatively, the first network entity may indicate multi-hop relay authorization information to the second network entity. For example, the first network entity may inform the second network entity whether the first network entity was authorized to allow access, or whether the second network entity is authorized, to allow access for multi-hop relaying or may indicate current multi-hop authorization information for the first network entity to the second network entity. Coordinating the multi-hop relay information between network entities may decrease system latency, improve user experience, and increase efficiency in mobility procedures (e.g., provide higher mobility support).

Aspects of the disclosure are initially described in the context of wireless communications systems. Aspects of the disclosure are further illustrated by and described with reference to process flows, apparatus diagrams, system diagrams, and flowcharts that relate to network coordination for multi-hop relays.

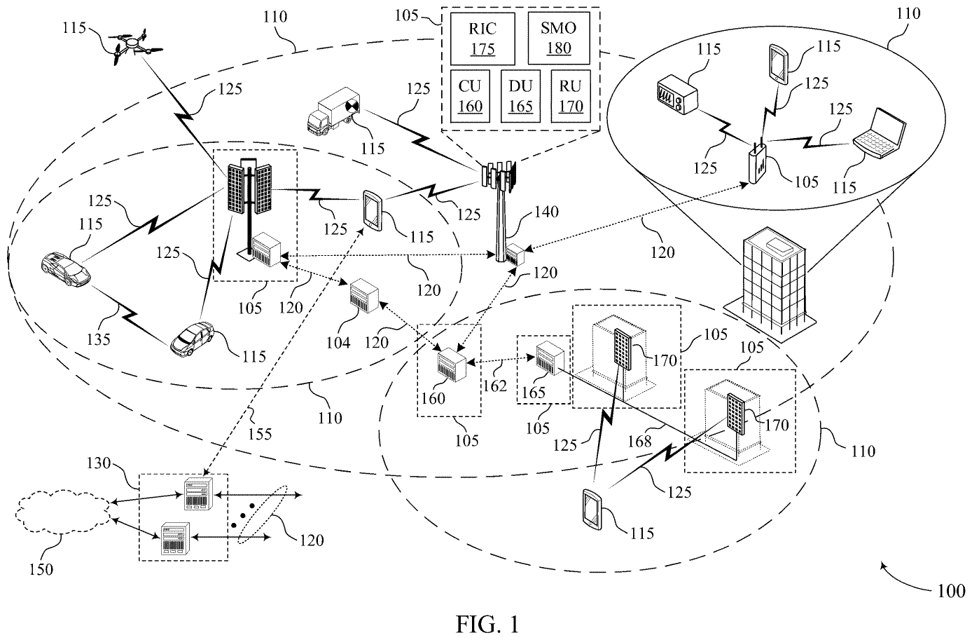

FIG. 1 shows an example of a wireless communications system 100 that supports network coordination for multi-hop relays in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support network coordination for multi-hop relays as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Network entities 105 may support network coordination for multi-hop relay configurations and mobility of multi-hop relay configurations. In some examples, a first UE 115 (e.g., a remote UE 115) may communicate with a first network entity 105 via a multi-hop relay configuration including a second UE 115 directly connected with the first network entity 105 (e.g., a donor relay UE 115) and one or more intermediate relay UEs 115 (e.g., connected via respective D2D communication links 135). That is, the second UE 115 and the one or more intermediate relay UEs 115 may forward communications between the first UE 115 and the first network entity 105.

The second UE 115 may experience a mobility event and may handover from the first network entity 105 to a second network entity 105. To support the mobility of (e.g., to maintain) the multi-hop relay configuration for the first UE 115, the second UE 115, and the one or more intermediate relay UEs 115, the first network entity 105 and the second network entity 105 may communicate to exchange information associated with the multi-hop relay configuration (e.g., parameters, authorizations, and the like). In some examples, the first network entity 105 may communicate a multi-hop indication, a route ID, a ProSe user info ID for the first UE 115, an ID for the second UE 115, a relay hop count, a first per-hop PC5 RLC CH configuration for E2E SRBs, a second per-hop PC5 RLC CH configuration for E2E DRBs, an authorization for multi-hop relay communications, among other information.

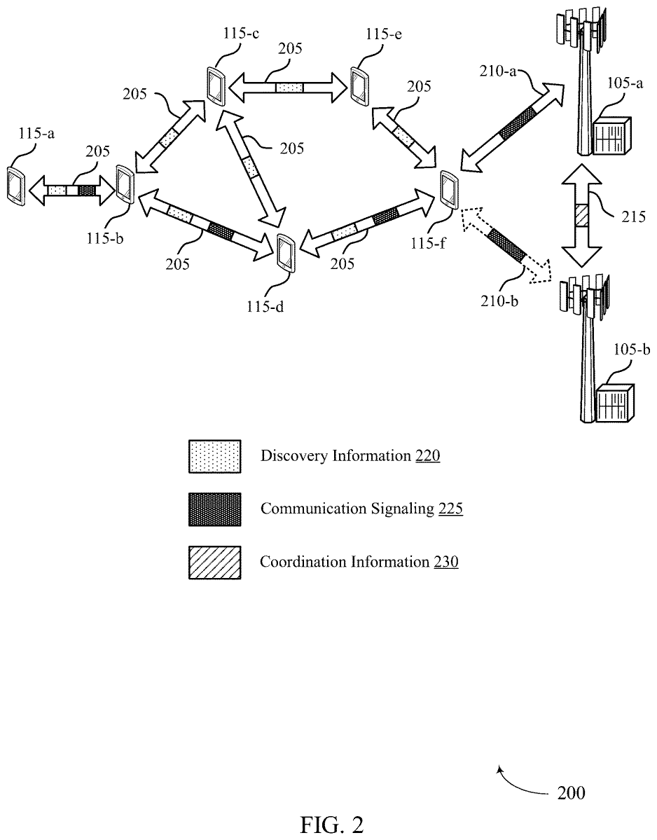

FIG. 2 shows an example of a wireless communications system 200 that supports network coordination for multi-hop relays in accordance with one or more aspects of the present disclosure. The wireless communications system 200 may implement or be implemented by aspects of the wireless communications system 100 as described with reference to FIG. 1. For example, the wireless communications system 200 may include multiple UEs 115 (e.g., a UE 115-a, a UE 115-b, a UE 115-c, etc.), a network entity 105-a, and a network entity 105-b, which may represent examples of UEs 115 and network entities 105 as described with reference to FIG. 1. Though shown as separate network entities, the network entity 105-a and the network entity 105-b may actually be a same network entity but with split functionality (e.g., a split gNB architecture). For example, the network entity 105-a may be a CU 160 (e.g., gNB-CU) and the network entity 105-b may be a DU 165 (e.g., gNB-DU) of the same network entity (e.g., network node).

The UEs 115 may establish sidelink connections 205 with other UEs 115 in the wireless communications system 200. The UEs 115 may also establish communication links 210 (e.g., Uu connections) with one or more network entities 105. The network entity 105-a and the network entity 105-b may communicate via a communication link 215 (e.g., a backhaul link, or a midhaul link, among other examples). In some cases, the devices described with reference to FIG. 2 may perform techniques as described herein to coordinate information associated with a multi-hop relay configuration and support mobility of the multi-hop relay configuration.

In some cases, the UEs 115 and the network entities 105 may support a relay configuration for communications (e.g., to extend network coverage or sidelink coverage). For instance, the relay configuration may be a single-hop relay configuration, where a first UE 115 (e.g., a remote UE, a source UE) communicates with a network entity 105 (e.g., a 5G network) or a second UE 115 (e.g., a destination UE 115) via a single intermediate relay UE 115 (e.g., a UE-to-network (U2N) relay UE 115, a UE-to-UE (U2U) relay UE 115). In some other cases, the relay configuration may be a multi-hop relay configuration (e.g., as illustrated in FIG. 2). In such cases, the first UE 115 may communicate with other devices (e.g., the network entity 105 or the destination UE 115) via multiple intermediate relay UEs 115 (e.g., via two or more relay UE hops).

The wireless communications system 200 may support an example of a multi-hop relay configuration (e.g., a multi-hop relay operation). The multiple UEs 115 may establish respective sidelink connections 205 with other UEs 115 via an exchange of discovery information 220. In some cases, a route (e.g., of multiple possible routes) between the intermediate relay UEs 115 may be selected for communication signaling 225 between the UE 115-a and the network entity 105-a. The selected route may be associated with a route ID (e.g., to distinguish from other routes). In the wireless communications system 200, a route for the communication signaling 225 may include the UE 115-a (e.g., the remote UE), the UE 115-b, the UE 115-d (e.g., intermediate relay UEs), the UE 115-f (e.g., the donor UE), and the network entity 105-a. In such examples, the network entity 105-a may communicate with the remote UE 115-a via the route (e.g., may transmit communication signaling 225 to the UE 115-f via the communication link 210-a, the UE 115-f may relay the communication signaling 225 to the UE 115-d via sidelink communication, the UE 115-d may relay the communication signaling 225 to the UE 115-b via sidelink communication, and the UE 115-b may relay the communication signaling 225 to the remote UE 115-a. FIG. 2 depicts an example of the route for the communication signaling 225, but it is to be understood that other routes may be possible (e.g., that include a UE 115-c or a UE 115-e).

In some cases, the UE 115-a may be out-of-coverage of the network entity 105-a and may use the multi-hop relay configuration to maintain communications with the network entity 105-a. Alternatively, the UE 115-a may be in-coverage of the network entity 105-a and may use the multi-hop relay configuration to improve communication quality. The UE 115-f may be in-coverage of the network entity 105-a and communicate directly with the network entity 105-a via the communication link 210-a (e.g., a Uu connection). The multiple intermediate relay UEs 115 may be in-coverage or out-of-coverage of the network entity 105-a.

The multi-hop relay configuration of the wireless communications system 200 may be supported by a multi-hop architecture (e.g., an architecture for multi-hop L2 U2N relay). For instance, the UE 115-a and the network entity 105-a may connect via one or more interfaces (e.g., a Uu-RRC interface and a PDCP interface). Additionally, the UE 115-a, the UE 115-b, the UE 115-d, and the UE 115-f may connect via one or more respective interfaces (e.g., respective PC5-RRC interfaces, PDCP interfaces, RLC interfaces, MAC interfaces, and PHY interfaces) over sidelink connections 205 (e.g., via respective PC5 connections). Further, the UE 115-f and the network entity 105-a may connect via one or more interfaces (e.g., a Uu-RRC interface, a PDCP interface, an RLC interface, a MAC interface and a PHY interface) over the communication link 210-a (e.g., via a Uu connection). Each device (e.g., the UE 115-a, the UE 115-b, the UE 115-d, the UE 115-f, and the network entity 105-a) may connect via a common communication layer (e.g., a sidelink relay adaption protocol (SRAP) layer) with respective interfaces (e.g., respective RLC interfaces) of each device.

In the multi-hop architecture, the UE 115-b and the UE 115-d (e.g., the intermediate relay UEs) may not be visible to the network entity 105-a. That is, there may be no RRC connection between the UE 115-b or the UE 115-d and the network entity 105-a. In some cases, the configuration of the UE 115-b and the UE 115-d may be preconfigured or may be configured by a sidelink (e.g., PC5) message. Further, the UE 115-f may be visible to the network entity 105-a. That is, there may be an RRC connection (e.g., via the Uu RRC interface) between the UE 115-f and the network entity 105-a. In some cases, the network entity 105-a may provide a Uu configuration to the UE 115-f, and the sidelink configuration of the UE 115-f may be preconfigured or configured by a sidlelink message.

In some cases, the UE 115-a, the UE 115-b, the UE 115-d, the UE 115-f, and the network entity 105-a may perform one or more procedures to establish the multi-hop relay configuration (e.g., a route ID assignment procedure, quality of service (QoS) flow procedure, an E2E SRB/DRB configuration procedure, an authorization procedure). As part of the one or more procedures, the devices in FIG. 2 may exchange one or more parameters associated with the multi-hop relay configuration. For example, the UE 115-f may provide (e.g., to the network entity 105-a) a multi-hop indication, a remote UE (e.g., UE 115-a) ProSe user info ID, donor relay UE (e.g., UE 115-f) information, a U2N relay hop count, or the like.

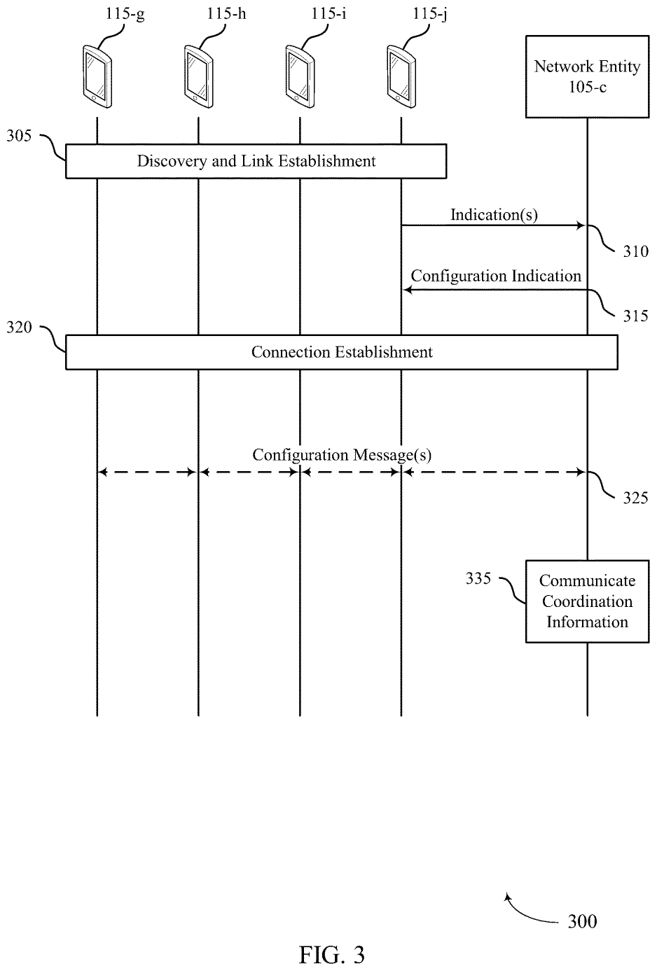

Additionally, or alternatively, the network entity 105-a may provide (e.g., to the UE 115-f) a route ID, an RLC channel configuration for each E2E SRB in the multi-hop configuration, an RLC channel configuration for each E2E DRB in the multi-hop configuration. The one or more procedures to establish the multi-hop relay configuration may be described in greater detail herein including with reference to FIG. 3.

In some cases, the network entity 105-a may also receive (e.g., from an access and mobility management function (AMF) or another network entity), or otherwise identify, authorization information. In some cases, current authorization procedures may indicate whether a relay UE 115 (e.g., single-hop relays) is authorized for communications. For example, in order to support sidelink RRC in a next generation radio access network (NG-RAN), authorization information (e.g., ProSe service authorization information) may be made available (e.g., by an AMF) to the network entity 105-a. The authorization information may enable operations (e.g., a Mode 1 operation) at the network entity 105-a to control resource management (e.g., a priority and aggregate maximum bit rate (AMBR)) for a relay UE 115.

In some cases, the AMF (not shown) may include the authorization information to the network entity 105-a (e.g., an NG-RAN node) as part of an NG application protocol (NGAP) procedure such as during an initial context setup procedure, a UE context modification procedure, a handover preparation procedure, or a path switch procedure. Additionally, or alternatively, another network entity (not shown) (e.g., a source gNB, an old gNB) may include the authorization information to the network entity 105-a (e.g., a target gNB, a new gNB) as part of an Xn application protocol (XnAP) procedure such as during a handover preparation procedure or a retrieve UE context procedure. Additionally, or alternatively, a CU network entity (not shown) (e.g., a CU 160, a gNB-CU) may include the authorization information to the network entity 105-a (e.g., a DU 165, a gNB-DU) as part of an F1 application protocol (F1AP) procedure such as during a UE context setup procedure or a UE context setup modification procedure.

In some cases, the authorization information may include one or more information elements (IEs) (e.g., 5G ProSe Authorized IE) to provide information on the authorization status of a relay UE 115 (e.g., authorization to use the 5G ProSe services). Some example IEs and their associated characteristics are shown in Table 1. The Presence column may indicate whether an IE is to be included in an IE message. For example, the IEs in Table 1 may be marked as optional (O) indicating that the IEs may or may not be included in an IE message.

TABLE 1

| | Pres- | IE type and | Semantics |
|---|---|---|---|
| IE/Group Name | ence | reference | description |
| 5G ProSe Direct | O | ENUMERATED | Indicates whether the |
| Discovery | | (authorized, not | UE is authorized for |
| | | authorized, . . .) | 5G ProSe Direct |
| | | | Discovery |
| 5G ProSe Direct | O | ENUMERATED | Indicates whether the |
| Communication | | (authorized, not | UE is authorized for |
| | | authorized, . . .) | 5G ProSe Direct |
| | | | Communication |
| 5G | O | ENUMERATED | Indicates whether the |
| ProSe Layer-2 UE- | | (authorized, not | UE is authorized for |
| to-Network Relay | | authorized, . . .) | 5G ProSe Layer-2 UE- |
| | | | to-Network Relay |
| 5G | O | ENUMERATED | Indicates whether the |
| ProSe Layer-3 UE- | | (authorized, not | UE is authorized for |
| to-Network Relay | | authorized, . . .) | 5G ProSe Layer-3 UE- |
| | | | to-Network Relay |
| 5G ProSe Layer-2 | O | ENUMERATED | Indicates whether the |
| Remote UE | | (authorized, not | UE is authorized for |
| | | authorized, . . .) | 5G ProSe Layer-2 |
| | | | Remote UE |

In some cases, as part of a mobility procedure, the UE 115-f may switch (e.g., handover) from the network entity 105-a to the network entity 105-b to maintain communication quality. For example, the UE 115-f and the network entity 105-b may establish a communication link 210-b as part of the mobility procedure (e.g., and may drop the communication link 210-a). However, the network entity 105-b may not have a context (e.g., the one or more parameters, the authorization information, the route ID, among other examples) associated with the multi-hop relay configuration. Further, authorization procedures may not be defined for multi-hop relay configurations, or for coordinating authorization procedures across multiple network entities, including the network entity 105-a and the network entity 105-b. As such, the wireless communications system 200 may experience increased latency and the multi-hop relay configuration may be disrupted during mobility procedures (e.g., handover procedures). For example, if the network entity 105-b does not have the context associated with the multi-hop relay configuration, the multi-hop relay configuration may drop based on a mobility to the 105-b. Thus, the network entity 105-b may reperform the one or more procedures to establish the multi-hop relay configuration with the UEs 115, which may result in redundancy, increased signaling overhead, and increased latency.

According to aspects described herein, the network entity 105-a and the network entity 105-b may coordinate to support mobility of the multi-hop relay configuration associated with the UEs 115 (e.g., may coordinate to maintain the multi-hop relay configuration for the UE 115-f and the additional UEs 115 for communication with remote UE 115-a, when the UE 115-f is no longer connected to the network entity 105-a). Aspects described herein may also provide authorization procedures for multi-hop relay configurations. In some examples, the network entity 105-a may exchange coordination information 230 with the network entity 105-b via the communication link 215 (e.g., via an Xn interface, an F1 interface) associated with the multi-hop configuration. As such, based on mobility of the UE 115-f to the network entity 105-b (e.g., a new gNB, a new gNB-DU associated with a same gNB-CU as the network entity 105-a), the network entity 105-b may obtain a context of the multi-hop configuration under the network entity 105-a (e.g., whether the network entity 105-a was serving a multi-hop relay, an assigned route ID, a remote UE ProSe user info ID, authorization information). In some examples, the coordination information 230 may include a multi-hop indication, a multi-hop route ID, a remote UE ProSe user info ID (e.g., of the UE 115-a), donor relay UE information (e.g., a donor relay UE ID), multi-hop relay authorization information, or a combination thereof.

Additionally, or alternatively, the coordination information 230 may include a multi-hop relay UE count (e.g., U2N relay hop count), a first sidelink RLC channel configuration for each E2E SRB of multiple E2E SRBs (e.g., a per-hop PC5 RLC CH config for E2E SRBs) associated with the UEs 115, a second sidelink RLC channel configuration for each E2E DRB of multiple E2E DRBs (e.g., a per-hop PC5 RLC CH config for E2E DRBs) associated with the UEs 115, or a combination thereof. In some examples, the network entity 105-a (e.g., a gNB-CU) or the network entity 105-b may signal an indication of the first sidelink RLC channel configuration, the second sidelink channel configuration, or both via a UE context setup procedure or a UE context modification procedure. For example, the network entity 105-a or the network entity 105-b may setup, release, or modify the first sidelink RLC channel configuration and the second sidelink RLC channel configuration (e.g., in response to the coordination information) and signal (e.g., transmit) an indication of an updated first sidelink RLC channel configuration, an updated first sidelink RLC channel configuration, or both via a UE context setup procedure or a UE context modification procedure.

In some examples, the coordination information 230 may be exchanged during handover preparation (e.g., in a HANDOVER REQUEST message over Xn), during a retrieve UE context procedure when the UE 115-f (e.g., the donor relay UE) resumes from RRC_INACTIVE onto the network entity 105-b (e.g., in a RETRIEVE UE CONTEXT RESPONSE message over Xn), or both. In some examples (e.g., in case of intra-gNB mobility), the network entity 105-a (e.g., a gNB-CU) may transmit the coordination information 230 to the network entity 105-b (e.g., a new gNB-DU) via a UE context setup procedure or a UE context modification procedure. In some examples, the coordination information 230 may be included in new fields of existing protocol messages.

In some examples, the wireless communications system 200 may support authorization procedures for multi-hop relay authorization. For example, an AMF network entity (not shown) may transmit a first indication (e.g., may inform) to the network entity 105-a (e.g., to an NG-RAN node, or the network entity 105-b) of whether the network entity 105-a is authorized to allow access for multi-hop relay UEs (e.g., prior to exchanging the coordination information 230). The first indication may occur during an initial context setup procedure, a UE context modification procedure, a handover preparation procedure, a path switch procedure, or a combination thereof.

The network entity 105-a (e.g., a source gNB, and old gNB) may include a second indication (e.g., may inform) in the coordination information 230 to the network entity 105-b (e.g., a target gNB, a new gNB) of the authorization of the network entity 105-a (e.g., via the communication link 215). That is, the network entity 105-a may indicate to the network entity 105-b whether the network entity 105-a was authorized to allow access for multi-hop relay UEs. In some examples, the second indication of the authorization may occur during a handover preparation procedure, a retrieve UE context procedure, or a combination thereof. In some examples (e.g., in cases of split gNB architecture), the network entity 105-a may be a CU 160 (e.g., a gNB-CU) and the network entity 105-b may be a DU 165 (e.g., a gNB-DU) and the second indication may occur during a UE context setup procedure, a UE context setup modification procedure, or both. The network entity 105-b may, in some examples, determine an authorization (e.g., its own authorization) based on the second indication from the network entity 105-a.

In some examples, the authorization information for muti-hop relays may be a same multi-hop authorization for various relay types. For example, the multi-hop authorization may be the same for L3 relays, L2 relays, U2N relays, and U2U relays. Alternatively, the multi-hop authorization may be different for at least one type of relay, or for each type of relay. For example, L3 relays, L2 relays, U2N relays, and U2U relays may all have a respective multi-hop authorization different from the others. In some examples, new information elements (IEs) may be introduced (e.g., into 5G ProSe Authorized IE, in addition to IEs listed in Table 1) for the multi-hop authorizations (e.g., each type of multi-hop authorization), or existing IEs (e.g., IEs in Table 1) may be modified (e.g., reused) with a new IE for hop type (e.g., single-hop or multi-hop). Coordinating information associated with the multi-hop configuration as described herein may increase the performance of the wireless communications system 200. For example, the techniques herein may provide for improved handover continuity, increased system efficiency, decreased latency, and higher mobility support in wireless communications systems.

FIG. 3 shows an example of a process flow 300 that supports network coordination for multi-hop relays in accordance with one or more aspects of the present disclosure. The process flow 300 may implement or be implemented by aspects of the wireless communications systems 100 and 200. For example, the process flow 300 may support the establishment of a multi-hop relay configuration between a UE 115-g (e.g., a remote relay UE), a UE 115-h, a UE 115-i (e.g., intermediate relay UEs), a UE 115-j (e.g., a donor relay UE), and a network entity 105-c. The device may be examples of corresponding devices herein, including with reference to FIGS. 1 and 2.

In the following description of process flow 300, the operations between the devices may be transmitted in a different order than the order shown, or other operations may be added or removed from the process flow 300. For example, some operations may also be left out of process flow 300, or may be performed in different orders or at different times. Further, although some operations or signaling may be shown to occur at different times for discussion purposes, these operations may actually occur at the same time. Although specific devices are shown performing the operations of process flow 300, some aspects of some operations may also be performed by one or more other wireless or network devices.

At 305, the UE 115-g (e.g., the remote UE), the UE 115-h, the UE 115-i (e.g., intermediate relay UEs), and the UE 115-j (e.g., the donor relay UE) may perform a first procedure for discovery and link establishment (e.g., via exchange of discovery information 220). In some cases, the procedure may include relay discovery (e.g., discovery of other UEs 115) and relay selection (e.g., selection of which UEs to connect with). The procedure may include a per-hop unicast link (e.g., PC5 unicast link) setup or modification (e.g., a per-hop route ID assignment) to establish a multi-hop relay route. The UEs 115 may exchange a setup message (e.g., an RRCSetupRequest message) to establish the link. In some cases, the setup message may be transmitted via a sidelink RLC channel (e.g., via SL-RLC0 on each PC5 hop). In some cases, the setup message may be part of an E2E RRC connection setup.

At 310, the UE 115-j may transmit one or more indications to the network entity 105-c. For example, the UE 115-j may transmit a multi-hop relay indication, a relay (e.g., U2N relay) hop count, ProSe user info ID for the UE 115-g, an ID associated with the UE 115-j, or a combination thereof to the network entity 105-c. Additionally, or alternatively, the UE 115-g may transmit the one or more indications (e.g., the remote UE ProSe user info ID). In some cases, the one or more indications may be transmitted via a supplemental user identification (SUI) message.

At 315, the network entity 105-c may transmit a configuration indication to the UE 115-j. The configuration indication may include an RRCReconfiguration message that contains a route ID (e.g., a multi-hop route ID). In some cases, the network entity 105-c may determine (e.g., assign) the route ID to indicate a route for relaying communications in the multi-hop relay configuration (e.g., based on the indication at 310) according to various methods. For example, the network entity 105-c may assign the route ID according to a unique E2E route ID, a unique per-hop route ID, or by reuse of a ProSe user info ID. In cases where the route ID is assigned according to the unique E2E route ID, the network entity 105-c may assign the route ID and configure to each of the UEs 115 (e.g., UE 115-g, UE 115-h, UE 115-i, and UE 115-j). The network entity 105-c may assign the route ID on a Uu SRAP interface and a PC5 SRAP interface. The UE 115-j or the UE 115-g may notify the intermediate UEs (e.g., UE 115-h and UE 115-i) of the route ID on the PC5 SRAP interface using a sidelink (e.g., PC5) message. In some cases, route ID collision may be possible when different network entities assign a same route ID (e.g., on PC5 SRAP), and a system may utilize a route ID collision management protocol to handle route ID collisions.

In cases where the route ID is assigned according to the unique per-hop route ID, the network entity 105-c may assign the route ID on the Uu SRAP interface (e.g., to the UE 115-j). In such cases, each relay UE 115 may assign the route ID for the next PC5 hop or for the last hop and may notify neighbor UEs 115. The UE 115-h and the UE 115-i and the UE 115-j may maintain a mapping of the route ID to the UE 115-g. Further, the uniqueness of the route ID may be in the scope of each UE 115 (e.g., each relay hop). That is, there may be no collision of route IDs (e.g., on each hop), and the length of the route may be shorter relative to other methods. In such cases, UEs 115 may switch the route ID on each hop until a message (e.g., a packet) reaches a destination.

In cases where the route ID is assigned by reuse of a ProSe user info ID, the network entity 105-c may reuse the ProSe user info ID of the UE 115-g (e.g., ProSe user info of the remote UE) indicated at 310. In some cases, the ProSe user info ID may be a string of bits (e.g., 48-bit string). The network entity 105-c may reuse the ProSe user info ID in an SRAP layer for each hop, which may include the PC5 interface and the Uu interface. In any case, the route ID may be included in a header (e.g., SRAP header may be enhanced with the route ID). For example, the route ID may be introduced in the SRAP header along with other header fields (e.g., D/C, R, a bearer ID, and a payload).

At 320, the UEs 115 may establish a connection (e.g., via the multi-hop configuration) with the network entity 105-c (e.g., based on the one or more configuration messages at 315). In some cases, establishing the connection may include a remote UE RRC connection setup procedure where, the UE 115-j may transmit an RRCSetupRequest message (e.g., via a default RLC channel configuration on each hop, via SL-RLC0) associated with the UE 115-g. For instance, the RRCSetupRequest may include an SRB0 for the UE 115-g. The network entity 105-c may transmit (e.g., in response to the RRCSetupRequest) an RRCSetup message to the UE 115-g via the multi-hop relay connection (e.g., via the UE 115-j, the UE 115-i, and the UE 115-h). In some cases, each UE 115 may relay the RRCSetup message via a sidelink RLC channel (e.g., via SL-RLC0 on each hop). The UE 115-g may respond via the multi-hop relay connection with an RRCSetupComplete message to finalize the connection establishment. In some cases, each relay UE 115 may relay the RRCSetupComplete message according to a default sidelink configuration (e.g., via a default per-hop PC5 RLC channel configuration for E2E SRB1). Additionally, or alternatively, each UE 115 may be configured (e.g., as part of an E2E RRC connection setup) by the network entity 105-c.

At 325, the network entity 105-c and the UEs 115 may communicate one or more configuration messages. In some cases, the network entity 105-c may split E2E QoS (e.g., delay between relay UEs 115) into Uu QoS and E2E PC5 QoS parts. For example, the network entity 105-c and the UE 115-j may communicate an RRCReconfiguration message that includes a Uu RLC channel configuration and E2E PC5 QoS parameters, and the UE 115-j (e.g., or the network entity 105-c) may communicate the RRCReconfiguration message with the other UEs 115 that includes an E2E bearer configuration (e.g., QoS for each UE 115) for E2E QoS flow. In such examples, the UE 115-j (e.g., as an L2 U2U relay) may initiate a PC5 link modification (e.g., QoS split) to split E2E PC5 QoS into per-hop PC5 QoS. In another example, the network entity 105-c may communicate the E2E PC5 QoS parameters (e.g., via the RRCReconfiguration message) with the UE 115-g via the relay UEs 115. In such examples, the UE 115-g (e.g., as an L2 U2U relay) may initiate a PC5 link modification (e.g., QoS split) to split E2E PC5 QoS into per-hop PC5 QoS.

In some cases, the RRCReconfiguration message from the network entity 105-c may include E2E radio bearer configuration information (e.g., SRAP configuration, PDCP configuration, QoS parameters, a logical channel ID) for each of the UEs 115. For example, the RRCReconfiguration message may include a Uu RLC channel configuration. The network entity 105-c may provide the E2E radio bearer configuration information (e.g., for E2E SRBs or E2E DRBs) to the UE 115-g or the UE 115-j. In some cases, the E2E radio bearer configuration information may include a per-hop PC5 RLC channel configuration for E2E SRBs or E2E DRBs. In some cases, the UE 115-g or the UE 115-j may forward the E2E radio bearer configuration information to the other UEs 115 (e.g., using PC5 RRC).

In some cases, the UEs 115 may apply the E2E radio bearer configuration (e.g., for E2E SRBs or E2E DRBs). In some cases, the UE 115-g or the UE 115-j may initiate a per-hop PC5 RRC procedure to forward the per-hop PC5 RLC channel configuration for SRBs to the other UEs 115. Alternatively, each UE 115 (e.g., each PC5 hop) may use a default PC5 RLC channel configuration. In some cases, a per-hop PC5 RLC channel configuration for E2E DRBs may be determined according to the per-hop E2E QoS information (e.g., communicated at 325). Alternatively, the network entity 105-c may provide a per-hop RLC channel configuration for E2E DRBs to the UE 115-g or the UE 115-j (e.g., in the RRCReconfiguration message), and the UE 115-g or the UE 115-j may initiate a per-hop PC5 RRC procedure to forward the per-hop PC5 RLC channel configuration for DRBs to the other UEs 115. In cases where the configuration is not forwarded, the UEs 115 (e.g., each PC5 hop) may use a default PC5 RLC channel configuration.

In some cases, due to a mobility event, the UE 115-j may switch from the network entity 105-c to a second network entity 105 (not shown). However, the second network entity 105 may not have information related to the multi-hop relay configuration. For example, the different network entity 105 may not have the information that is determined or communicated in the process flow 300 such as the one or more indications at 310, the configuration indication at 315, or information in the one or more configuration messages at 325. Thus, the multi-hop relay configuration of the UEs 115 may be disrupted during a mobility procedure, or the mobility procedure may increase latency and resource usage.

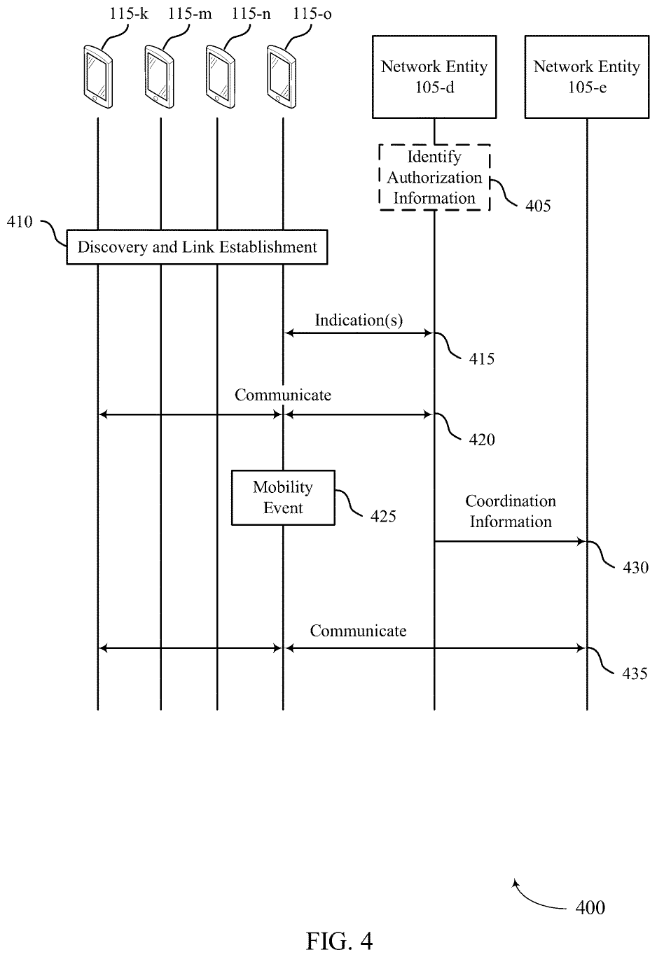

At 335, according to aspects herein, and as described in greater detail with reference to FIGS. 2 and 4, the network entity 105-c (e.g., a source network entity) may communicate coordination information with the second network entity (e.g., a target network entity) to support mobility of muti-hop relay configurations. In some examples, the network entity 105-c may communicate one or more parameters associated with the procedures as described in 305, 310, 315, 320, and 325 to the second network entity. For example, the network entity 105-c may transmit (e.g., via an Xn interface or an F1 interface) a multi hop indication, a multi-hop route ID, a multi-hop relay (e.g., U2N relay hop) count, a ProSe user information ID of the UE 115-g, an ID of the UE 115-j, a first RLC configuration for each E2E SRB (e.g., a per-hop PC5 RLC CH configuration for E2E SRBs) in the multi-hop configuration, a second RLC configuration for each E2E DRB (e.g., a per-hop PC5 RLC CH config for E2E DRBs) in the multi-hop configuration, or a combination thereof. In some examples, the network entity 105-c may communicate the coordination information at 335 via the coordination information 230. Coordinating multi-hop relay configuration information between network entities may increase system efficiency and provide increased support for mobility procedures.

FIG. 4 shows an example of a process flow 400 that supports network coordination for multi-hop relays in accordance with one or more aspects of the present disclosure. The process flow 400 may implement or be implemented by aspects of the wireless communications systems 100 and 200. For example, the process flow 400 may support coordination of multi-hop relay configuration information and authorization of multi-hop relays between multiple network entities. The process flow 400 may include a UE 115-k, a UE 115-m, a UE 115-n, a UE 115-0, a network entity 105-d, and a network entity 105-e, which may be examples of corresponding devices herein, including with reference to FIGS. 1 through 3.

In the following description of process flow 400, the operations between the UEs 115 and the network entities 105 may be transmitted in a different order than the order shown, or other operations may be added or removed from the process flow 400. For example, some operations may also be left out of process flow 400, or may be performed in different orders or at different times. Further, although some operations or signaling may be shown to occur at different times for discussion purposes, these operations may actually occur at the same time. Although the UE 115-k, the UE 115-m, the UE 115-n, the UE 115-0, the network entity 105-d and the network entity 105-e are shown performing the operations of process flow 400, some aspects of some operations may also be performed by one or more other wireless or network devices.

At 405, the network entity 105-d may identify authorization information. For example, the network entity 105-d may receive, from another network entity 105 (not shown), an authorization message that indicates that the network entity 105-d is authorized to allow access for a multi-hop relay operation. In some examples, the other network entity 105 may be an AMF and the network entity 105-d may be an NG-RAN node. The authorization information may be identified (e.g., received) as part of an initial context setup procedure, a UE context modification procedure, a handover preparation procedure, a path switch procedure, or a combination thereof between the network entity 105-d and the other network entity 105.

At 410, the UE 115-k (e.g., the remote UE), the UE 115-m, the UE 115-n (e.g., the intermediate relay UEs), and the UE 115-0 (e.g., the donor relay UE) may perform discovery and link establishment procedures. The UEs 115 may perform the discovery and link establishment procedures as described in greater detail with reference to FIG. 3. For example, the UEs 115 may perform the discovery and link establishment by using discovery information 220 that includes one or more setup messages (e.g., sidelink setup messages). In some cases, the UE 115-o may be in-coverage of the network entity 105-d, while the UE 115-k, the UE 115-m, and the UE 115-n may be out-of-coverage. As such, the UEs 115 may perform discovery and link establishment to support communications between the UE 115-k and the network entity 105-d.

At 415, the UE 115-o and the network entity 105-d may communicate one or more indications for a multi-hop relay operation. In some examples, the UE 115-o and the network entity 105-d may communicate the one or more indication as described in greater detail with reference to FIGS. 2 and 3. For example, the UE 115-o may report, or the network entity 105-d may transmit to the UE 115-0 (or a combination thereof), information supporting the multi-hop relay procedures. The one or more indications may include a multi-hop relay indication, a multi-hop route ID, a multi-hop relay count, a ProSe user information ID of the UE 115-k, an ID of the UE 115-0, a first sidelink RLC channel configuration for each E2E SRB of multiple E2E SRBs associated with the UEs 115 (e.g., a per-hop PC5 RLC CH configuration for E2E SRBs), a second sidelink RLC channel configuration for each E2E DRB of multiple E2E DRBs associated with the UEs 115 (e.g., a per-hop PC5 RLC CH configuration for E2E DRBs), or a combination thereof.

At 420, the network entity 105-d may communicate with the UE 115-o based on one or more parameters (e.g., the one or more indications at 415) for the multi-hop relay operation associated with the multiple UEs 115 (e.g., including the UE 115-0). The network entity 105-d may communicate with the UE 115-k (e.g., a remote UE, which may be at least a second UE 115 of the multiple UEs 115) via the UE 115-0 according to the one or more parameters for the multi-hop relay operation associated with the multiple UEs 115. In some examples, the network entity 105-d may communicate with the UE 115-k according to the one or more parameters for the multi-hop relay operation based on the authorization message (e.g., at 405).

At 425, the UE 115-o may experience a mobility event that causes the UE 115-o to switch (e.g., perform a handover procedure) from the network entity 105-d (e.g., a source network entity) to the network entity 105-e (e.g., a target network entity, a new network entity). For example, the mobility event may occur as a result of the UE 115-o moving out of the coverage area of the network entity 105-d and into the coverage area of the network entity 105-e. The mobility event may also occur (e.g., the UE 115-o may switch from communicating via a connection with the network entity 105-d to communicating via a connection with the network entity 105-e) due to other conditions such as environmental conditions, network conditions (e.g., network load), communication quality conditions, or the like.

At 430, the network entity 105-e (e.g., based on mobility of the UE 115-0) may receive coordination information from the network entity 105-d (e.g., via Xn, F1, or both). In some examples, the network entity 105-e may be a DU network entity and the network entity 105-d may be a CU network entity. The coordination information may include a coordination information message associated with the UE 115-0 (e.g., associated with the multi-hop configuration including the UE 115-0). The coordination information message may include one or more parameters for a multi-hop relay operation associated with the UEs 115 (e.g., including the UE 115-0). In some examples, the network entity 105-e may receive, via the one or more parameters of the coordination information message, a multi-hop indication, a multi-hop route ID, a multi-hop relay count, or any combination thereof. Additionally, or alternatively, the one or more parameters of the coordination information message may include a ProSe user information ID of the UE 115-k, an ID of the UE 115-0, or both.

Additionally, or alternatively, the network entity 105-e may receive, via the one or more parameters of the coordination information message, a first sidelink RLC channel configuration for each E2E SRB of multiple E2E SRBs associated with the multiple UEs 115 (e.g., a per-hop PC5 RLC CH configuration for E2E SRBs), a second sidelink RLC channel configuration for each E2E DRB of multiple E2E DRBs associated with the multiple UEs 115 (e.g., a per-hop PC5 RLC CH configuration for E2E DRBs), or both. In some cases, the network entity 105-d (e.g., a CU network entity) or the network entity 105-e may signal an indication of the first sidelink RLC channel configuration, the second sidelink RLC channel configuration, or both as part of a UE context setup procedure or a UE context modification procedure. For example, the network entity 105-d or the network entity 105-e may setup, release, or modify the first sidelink RLC channel configuration and the second sidelink RLC channel configuration (e.g., based on receiving the coordination information message).

In some cases, the network entity 105-e may receive, the coordination information message via a backhaul signaling message (e.g., a context message) during a handover procedure (e.g., in a HANDOVER REQUEST message over Xn) between the network entity 105-e and the network entity 105-d. In some cases, the network entity 105-e may receive the coordination information message via a backhaul signaling message (e.g., a context message) during a UE context retrieval procedure (e.g., when the UE 115-o resumes from RRC_INACTIVE to a new network entity, in a RETRIEVE UE CONTEXT RESPONSE message over Xn), a UE context setup procedure, a UE context modification procedure, or any combination thereof.

In some examples, the network entity 105-e may receive, via the coordination information message, an authorization message from the network entity 105-d. The authorization message may indicate that the network entity 105-d supports access for the multi-hop relay operation. The network entity 105-e may determine an authorization (e.g., its own authorization) based on the authorization message received from the network entity 105-d. In some examples, the authorization message may correspond to a same authorization for each relay type. For example, the authorization message may correspond to an L2 relay authorization, an L3 relay authorization, a U2N relay authorization, and a U2U authorization. Alternatively, the authorization message may include different respective authorizations for each relay type. For example, the authorization message may include a first authorization for an L2 relay authorization, a second authorization for an L3 authorization, a third authorization for a U2N relay authorization, a fourth authorization for a U2U authorization, or any combination thereof. In some cases, new IEs may be introduced for each type of authorization, or existing IEs may be modified (e.g., reused) to include a new IE hop type for multi-hop relay authorization.

At 435, the network entity 105-e may communicate with the UE 115-o based on receiving the coordination information message (e.g., at 430). The network entity 105-e may communicate with the UE 115-k (e.g., at least a second UE of the multiple UEs 115, a remote UE of the multi-hop relay) via the UE 115-0 (e.g., the donor UE of the multi-hop relay) according to the multi-hop relay operation and the coordination information message received at 430. For example, the network entity 105-e may use the one or more parameters for the multi-hop relay operation and the authorization information to perform communications with the UE 115-k via the UE 115-0, the UE 115-n, and the UE 115-m. Coordination of the multi-hop relay configuration between the network entities 105, as described herein, may enable the network entity 105-e (e.g., a target network entity) to obtain a context of the multi-hop relay configuration which may support increased efficiency in UE mobility operations.

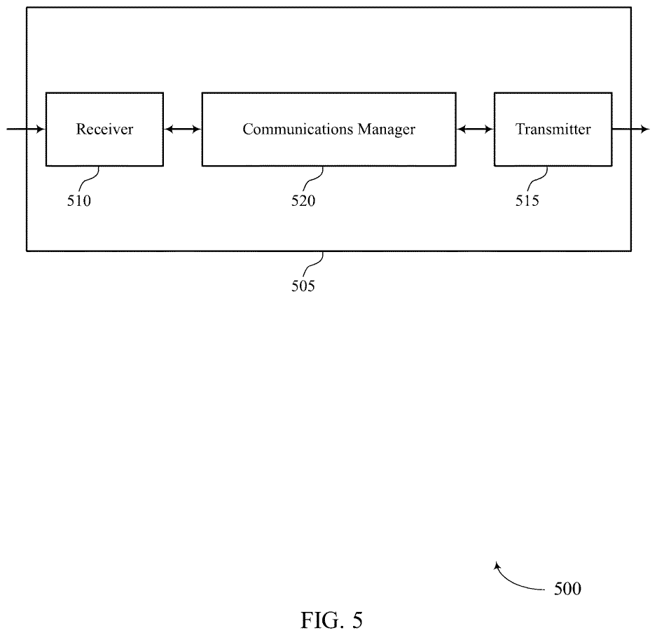

FIG. 5 shows a block diagram 500 of a device 505 that supports network coordination for multi-hop relays in accordance with one or more aspects of the present disclosure. The device 505 may be an example of aspects of a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of network coordination for multi-hop relays as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for receiving a coordination information message for a first UE, the coordination information message including one or more parameters for a multi-hop relay operation associated with a set of multiple UEs including the first UE. The communications manager 520 is capable of, configured to, or operable to support a means for communicating with the first UE based on receiving the coordination information message. The communications manager 520 is capable of, configured to, or operable to support a means for communicating with at least a second UE of the set of multiple UEs via the first UE according to the multi-hop relay operation and the coordination information message.

For example, the communications manager 520 is capable of, configured to, or operable to support a means for communicating with a first UE based on one or more parameters for a multi-hop relay operation associated with a set of multiple UEs including the first UE. The communications manager 520 is capable of, configured to, or operable to support a means for communicating with at least a second UE of the set of multiple UEs via the first UE according to the one or more parameters for the multi-hop relay operation associated with the set of multiple UEs. The communications manager 520 is capable of, configured to, or operable to support a means for transmitting a coordination information message for the first UE, the coordination information message including the one or more parameters for the multi-hop relay operation associated with the set of multiple UEs including the first UE.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

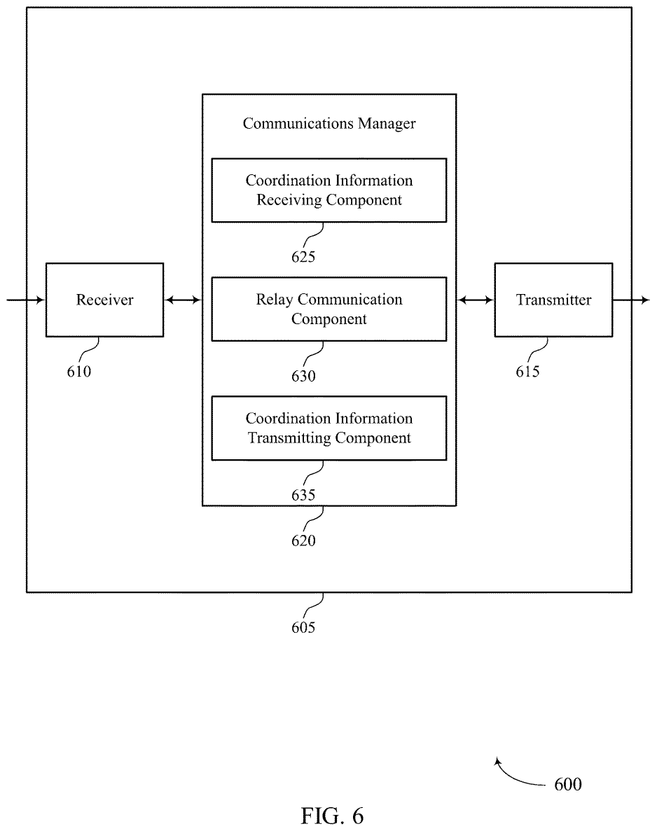

FIG. 6 shows a block diagram 600 of a device 605 that supports network coordination for multi-hop relays in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of network coordination for multi-hop relays as described herein. For example, the communications manager 620 may include a coordination information receiving component 625, a relay communication component 630, a coordination information transmitting component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The coordination information receiving component 625 is capable of, configured to, or operable to support a means for receiving a coordination information message for a first UE, the coordination information message including one or more parameters for a multi-hop relay operation associated with a set of multiple UEs including the first UE. The relay communication component 630 is capable of, configured to, or operable to support a means for communicating with the first UE based on receiving the coordination information message. The relay communication component 630 is capable of, configured to, or operable to support a means for communicating with at least a second UE of the set of multiple UEs via the first UE according to the multi-hop relay operation and the coordination information message.

The relay communication component 630 is capable of, configured to, or operable to support a means for communicating with a first UE based on one or more parameters for a multi-hop relay operation associated with a set of multiple UEs including the first UE. The relay communication component 630 is capable of, configured to, or operable to support a means for communicating with at least a second UE of the set of multiple UEs via the first UE according to the one or more parameters for the multi-hop relay operation associated with the set of multiple UEs. The coordination information transmitting component 635 is capable of, configured to, or operable to support a means for transmitting a coordination information message for the first UE, the coordination information message including the one or more parameters for the multi-hop relay operation associated with the set of multiple UEs including the first UE.

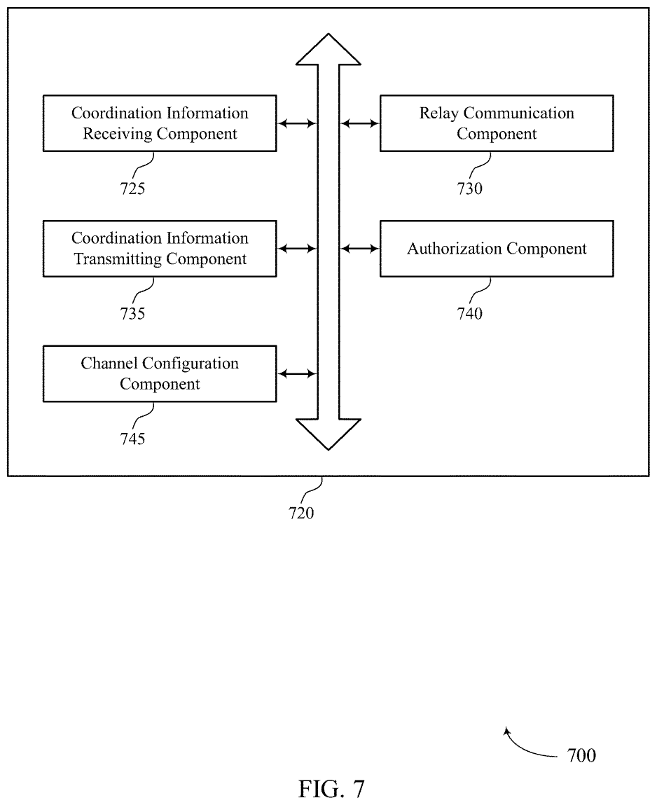

FIG. 7 shows a block diagram 700 of a communications manager 720 that supports network coordination for multi-hop relays in accordance with one or more aspects of the present disclosure. The communications manager 720 may be an example of aspects of a communications manager 520, a communications manager 620, or both, as described herein. The communications manager 720, or various components thereof, may be an example of means for performing various aspects of network coordination for multi-hop relays as described herein. For example, the communications manager 720 may include a coordination information receiving component 725, a relay communication component 730, a coordination information transmitting component 735, an authorization component 740, a channel configuration component 745, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The coordination information receiving component 725 is capable of, configured to, or operable to support a means for receiving a coordination information message for a first UE, the coordination information message including one or more parameters for a multi-hop relay operation associated with a set of multiple UEs including the first UE. The relay communication component 730 is capable of, configured to, or operable to support a means for communicating with the first UE based on receiving the coordination information message. In some examples, the relay communication component 730 is capable of, configured to, or operable to support a means for communicating with at least a second UE of the set of multiple UEs via the first UE according to the multi-hop relay operation and the coordination information message.

In some examples, the coordination information receiving component 725 is capable of, configured to, or operable to support a means for receiving, via the one or more parameters of the coordination information message, a multi-hop indication, a multi-hop route ID, a multi-hop relay count, or any combination thereof. In some examples, the coordination information receiving component 725 is capable of, configured to, or operable to support a means for receiving, via the one or more parameters of the coordination information message, a ProSe user information ID of the second UE, an ID of the first UE, or any combination thereof.

In some examples, the coordination information receiving component 725 is capable of, configured to, or operable to support a means for receiving, via the one or more parameters of the coordination information message, a first sidelink RLC channel configuration for each E2E SRB of a set of multiple E2E SRBs associated with the set of multiple UEs, a second sidelink RLC channel configuration for each E2E DRB of a set of multiple E2E DRBs associated with the set of multiple UEs, or both.

In some examples, the channel configuration component 745 is capable of, configured to, or operable to support a means for signaling an indication of the first sidelink RLC channel configuration, the second sidelink RLC channel configuration, or both as part of a UE context setup procedure or a UE context modification procedure.

In some examples, the coordination information receiving component 725 is capable of, configured to, or operable to support a means for receiving the coordination information message via a backhaul signaling message during a handover procedure between the network entity and another network entity. In some examples, the coordination information receiving component 725 is capable of, configured to, or operable to support a means for receiving the coordination information message via a backhaul signaling message during a UE context retrieval procedure, a UE context setup procedure, a UE context modification procedure, or any combination thereof.

In some examples, the coordination information receiving component 725 is capable of, configured to, or operable to support a means for receiving, via the coordination information message, an authorization message that indicates that another network entity supports access for the multi-hop relay operation. In some examples, the authorization message corresponds to an L2 relay authorization, an L3 relay authorization, a U2N relay authorization, and a U2U authorization. In some examples, the authorization message includes a first authorization for an L2 relay authorization, a second authorization for an L3 relay authorization, a third authorization including a U2N relay authorization, a fourth authorization including a U2U authorization, or any combination thereof.

In some examples, to support receiving the coordination information message, the coordination information receiving component 725 is capable of, configured to, or operable to support a means for receiving the coordination information message from another network entity, where the network entity includes a DU network entity and the other network entity includes a CU network entity.

In some examples, the relay communication component 730 is capable of, configured to, or operable to support a means for communicating with a first UE based on one or more parameters for a multi-hop relay operation associated with a set of multiple UEs including the first UE. In some examples, the relay communication component 730 is capable of, configured to, or operable to support a means for communicating with at least a second UE of the set of multiple UEs via the first UE according to the one or more parameters for the multi-hop relay operation associated with the set of multiple UEs. The coordination information transmitting component 735 is capable of, configured to, or operable to support a means for transmitting a coordination information message for the first UE, the coordination information message including the one or more parameters for the multi-hop relay operation associated with the set of multiple UEs including the first UE.

In some examples, the coordination information transmitting component 735 is capable of, configured to, or operable to support a means for transmitting, via the one or more parameters of the coordination information message, a multi-hop indication, a multi-hop route ID, a multi-hop relay count, or any combination thereof. In some examples, the coordination information transmitting component 735 is capable of, configured to, or operable to support a means for transmitting, via the one or more parameters of the coordination information message, a ProSe user information ID of the second UE, an ID of the first UE, or any combination thereof.

In some examples, the coordination information transmitting component 735 is capable of, configured to, or operable to support a means for transmitting, via the one or more parameters of the coordination information message, a first sidelink RLC channel configuration for each E2E SRB of a set of multiple E2E SRBs associated with the set of multiple UEs, a second sidelink RLC channel configuration for each E2E DRB of a set of multiple E2E DRBs associated with the set of multiple UEs, or both.

In some examples, the channel configuration component 745 is capable of, configured to, or operable to support a means for signaling an indication of the first sidelink RLC channel configuration, the second sidelink RLC channel configuration, or both as part of a UE context setup procedure or a UE context modification procedure.

In some examples, the coordination information transmitting component 735 is capable of, configured to, or operable to support a means for transmitting the coordination information message via a backhaul signaling message during a handover procedure between the network entity and another network entity. In some examples, the coordination information transmitting component 735 is capable of, configured to, or operable to support a means for transmitting the coordination information message via a backhaul signaling message during a UE context retrieval procedure, a UE context setup procedure, a UE context modification procedure, or any combination thereof.

In some examples, the authorization component 740 is capable of, configured to, or operable to support a means for receiving, from another network entity, an authorization message that indicates that the network entity is authorized to allow access for the multi-hop relay operation, where communicating with the second UE according to the one or more parameters for the multi-hop relay operation is based on the authorization message. In some examples, the coordination information transmitting component 735 is capable of, configured to, or operable to support a means for transmitting, via the coordination information message, the authorization message.

In some examples, the coordination information transmitting component 735 is capable of, configured to, or operable to support a means for transmitting, via the coordination information message, an authorization message that indicates that the network entity supports access for the multi-hop relay operation. In some examples, the authorization message corresponds to an L2 relay authorization, an L3 relay authorization, a U2N relay authorization, and a U2U authorization. In some examples, the authorization message includes a first authorization for an L2 relay authorization, a second authorization for an L3 relay authorization, a third authorization including a U2N relay authorization, a fourth authorization including a U2U authorization, or any combination thereof.

In some examples, to support transmitting the coordination information message, the coordination information transmitting component 735 is capable of, configured to, or operable to support a means for transmitting the coordination information message to another network entity, where the other network entity includes a DU network entity and the network entity includes a CU network entity.

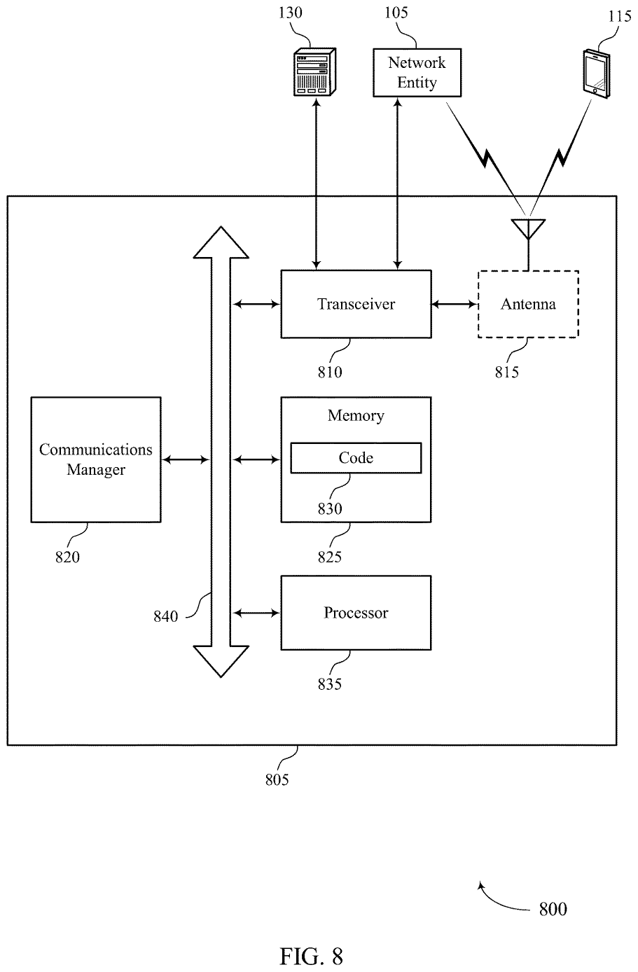

FIG. 8 shows a diagram of a system 800 including a device 805 that supports network coordination for multi-hop relays in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or memory components (for example, the processor 835, or the memory 825, or both), may be included in a chip or chip assembly that is installed in the device 805. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting network coordination for multi-hop relays). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805. The processor 835 may be any one or more suitable processors capable of executing scripts or instructions of one or more software programs stored in the device 805 (such as within the memory 825). In some implementations, the processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

For example, the communications manager 820 is capable of, configured to, or operable to support a means for receiving a coordination information message for a first UE, the coordination information message including one or more parameters for a multi-hop relay operation associated with a set of multiple UEs including the first UE. The communications manager 820 is capable of, configured to, or operable to support a means for communicating with the first UE based on receiving the coordination information message. The communications manager 820 is capable of, configured to, or operable to support a means for communicating with at least a second UE of the set of multiple UEs via the first UE according to the multi-hop relay operation and the coordination information message.

For example, the communications manager 820 is capable of, configured to, or operable to support a means for communicating with a first UE based on one or more parameters for a multi-hop relay operation associated with a set of multiple UEs including the first UE. The communications manager 820 is capable of, configured to, or operable to support a means for communicating with at least a second UE of the set of multiple UEs via the first UE according to the one or more parameters for the multi-hop relay operation associated with the set of multiple UEs. The communications manager 820 is capable of, configured to, or operable to support a means for transmitting a coordination information message for the first UE, the coordination information message including the one or more parameters for the multi-hop relay operation associated with the set of multiple UEs including the first UE.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, and improved utilization of processing capability, among other benefits.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, the processor 835, the memory 825, the code 830, or any combination thereof. For example, the code 830 may include instructions executable by the processor 835 to cause the device 805 to perform various aspects of network coordination for multi-hop relays as described herein, or the processor 835 and the memory 825 may be otherwise configured to perform or support such operations.

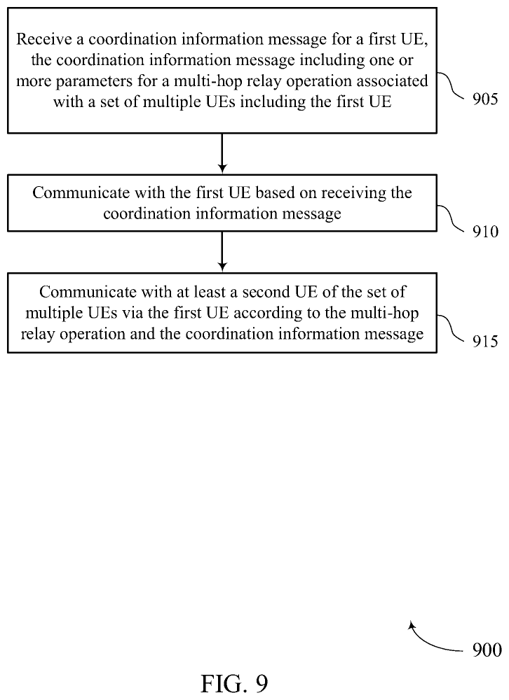

FIG. 9 shows a flowchart illustrating a method 900 that supports network coordination for multi-hop relays in accordance with aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the wireless network entity to perform the described functions. Additionally, or alternatively, the wireless network entity may perform aspects of the described functions using special-purpose hardware.

At 905, the method may include receiving a coordination information message for a first UE, the coordination information message including one or more parameters for a multi-hop relay operation associated with a set of multiple UEs including the first UE. The operations of 905 may be performed in accordance with examples as disclosed herein. In some examples, aspects of the operations of 905 may be performed by a coordination information receiving component 725 as described with reference to FIG. 7.

At 910, the method may include communicating with the first UE based on receiving the coordination information message. The operations of 910 may be performed in accordance with examples as disclosed herein. In some examples, aspects of the operations of 910 may be performed by a relay communication component 730 as described with reference to FIG. 7.

At 915, the method may include communicating with at least a second UE of the set of multiple UEs via the first UE according to the multi-hop relay operation and the coordination information message. The operations of 915 may be performed in accordance with examples as disclosed herein. In some examples, aspects of the operations of 915 may be performed by a relay communication component 730 as described with reference to FIG. 7.

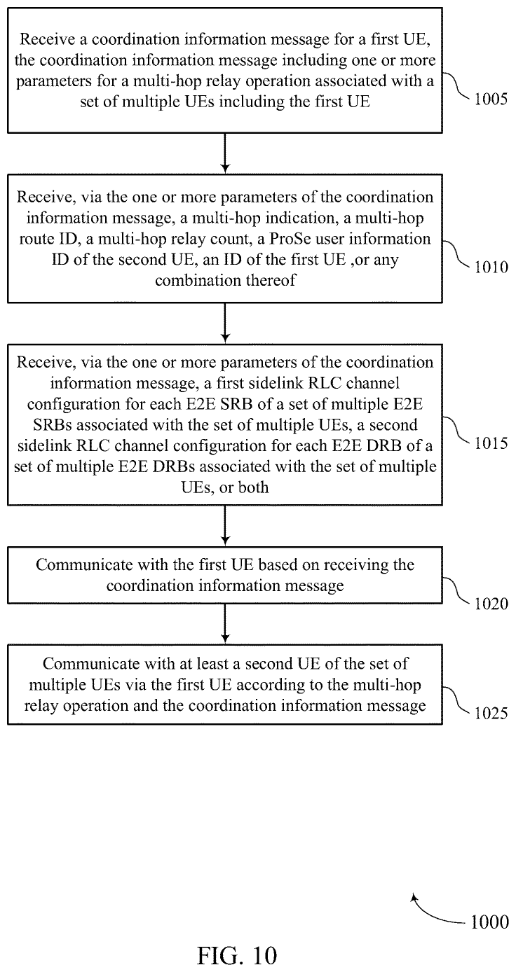

FIG. 10 shows a flowchart illustrating a method 1000 that supports network coordination for multi-hop relays in accordance with aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the wireless network entity to perform the described functions. Additionally, or alternatively, the wireless network entity may perform aspects of the described functions using special-purpose hardware.

At 1005, the method may include receiving a coordination information message for a first UE, the coordination information message including one or more parameters for a multi-hop relay operation associated with a set of multiple UEs including the first UE. The operations of 1005 may be performed in accordance with examples as disclosed herein. In some examples, aspects of the operations of 1005 may be performed by a coordination information receiving component 725 as described with reference to FIG. 7.

At 1010, the method may include receiving, via the one or more parameters of the coordination information message, a multi-hop indication, a multi-hop route ID, a multi-hop relay count, a ProSe user information ID of the second UE, an ID of the first UE, or any combination thereof. The operations of 1010 may be performed in accordance with examples as disclosed herein. In some examples, aspects of the operations of 1010 may be performed by a coordination information receiving component 725 as described with reference to FIG. 7.

At 1015, the method may include receiving, via the one or more parameters of the coordination information message, a first sidelink RLC channel configuration for each E2E SRB of a set of multiple E2E SRBs associated with the set of multiple UEs, a second sidelink RLC channel configuration for each E2E DRB of a set of multiple E2E DRBs associated with the set of multiple UEs, or both. The operations of 1015 may be performed in accordance with examples as disclosed herein. In some examples, aspects of the operations of 1015 may be performed by a coordination information receiving component 725 as described with reference to FIG. 7.

At 1020, the method may include communicating with the first UE based on receiving the coordination information message. The operations of 1020 may be performed in accordance with examples as disclosed herein. In some examples, aspects of the operations of 1020 may be performed by a relay communication component 730 as described with reference to FIG. 7.

At 1025, the method may include communicating with at least a second UE of the set of multiple UEs via the first UE according to the multi-hop relay operation and the coordination information message. The operations of 1025 may be performed in accordance with examples as disclosed herein. In some examples, aspects of the operations of 1025 may be performed by a relay communication component 730 as described with reference to FIG. 7.

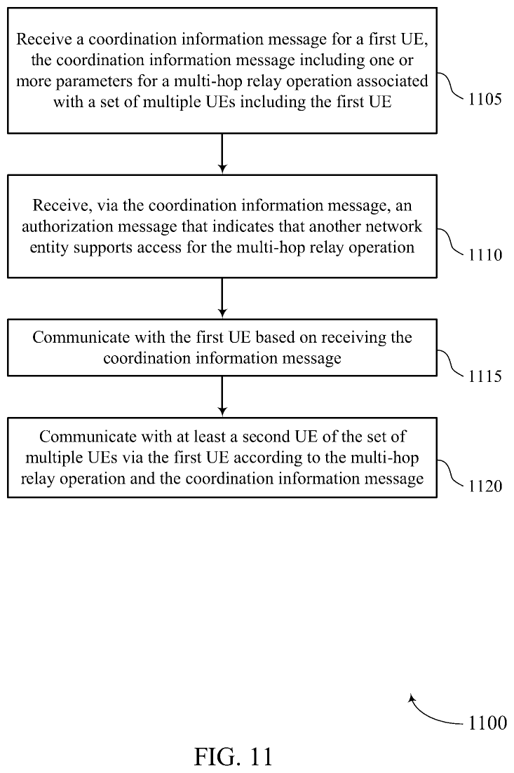

FIG. 11 shows a flowchart illustrating a method 1100 that supports network coordination for multi-hop relays in accordance with aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the wireless network entity to perform the described functions. Additionally, or alternatively, the wireless network entity may perform aspects of the described functions using special-purpose hardware.

At 1105, the method may include receiving a coordination information message for a first UE, the coordination information message including one or more parameters for a multi-hop relay operation associated with a set of multiple UEs including the first UE. The operations of 1105 may be performed in accordance with examples as disclosed herein. In some examples, aspects of the operations of 1105 may be performed by a coordination information receiving component 725 as described with reference to FIG. 7.

At 1110, the method may include receiving, via the coordination information message, an authorization message that indicates that another network entity supports access for the multi-hop relay operation. The operations of 1110 may be performed in accordance with examples as disclosed herein. In some examples, aspects of the operations of 1110 may be performed by a coordination information receiving component 725 as described with reference to FIG. 7.

At 1115, the method may include communicating with the first UE based on receiving the coordination information message. The operations of 1115 may be performed in accordance with examples as disclosed herein. In some examples, aspects of the operations of 1115 may be performed by a relay communication component 730 as described with reference to FIG. 7.

At 1120, the method may include communicating with at least a second UE of the set of multiple UEs via the first UE according to the multi-hop relay operation and the coordination information message. The operations of 1120 may be performed in accordance with examples as disclosed herein. In some examples, aspects of the operations of 1120 may be performed by a relay communication component 730 as described with reference to FIG. 7.

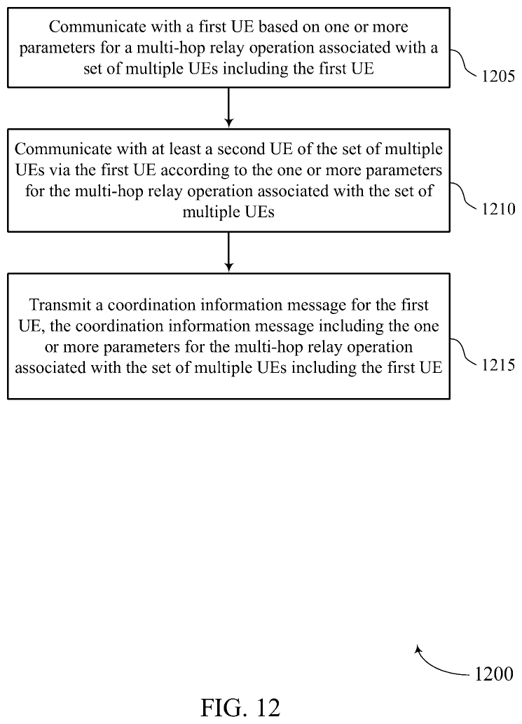

FIG. 12 shows a flowchart illustrating a method 1200 that supports network coordination for multi-hop relays in accordance with aspects of the present disclosure. The operations of the method 1200 may be implemented by a network entity or its components as described herein. For example, the operations of the method 1200 may be performed by a network entity as described with reference to FIGS. 1 through 8. In some examples, a network entity may execute a set of instructions to control the functional elements of the wireless network entity to perform the described functions. Additionally, or alternatively, the wireless network entity may perform aspects of the described functions using special-purpose hardware.

At 1205, the method may include communicating with a first UE based on one or more parameters for a multi-hop relay operation associated with a set of multiple UEs including the first UE. The operations of 1205 may be performed in accordance with examples as disclosed herein. In some examples, aspects of the operations of 1205 may be performed by a relay communication component 730 as described with reference to FIG. 7.

At 1210, the method may include communicating with at least a second UE of the set of multiple UEs via the first UE according to the one or more parameters for the multi-hop relay operation associated with the set of multiple UEs. The operations of 1210 may be performed in accordance with examples as disclosed herein. In some examples, aspects of the operations of 1210 may be performed by a relay communication component 730 as described with reference to FIG. 7.

At 1215, the method may include transmitting a coordination information message for the first UE, the coordination information message including the one or more parameters for the multi-hop relay operation associated with the set of multiple UEs including the first UE. The operations of 1215 may be performed in accordance with examples as disclosed herein. In some examples, aspects of the operations of 1215 may be performed by a coordination information transmitting component 735 as described with reference to FIG. 7.

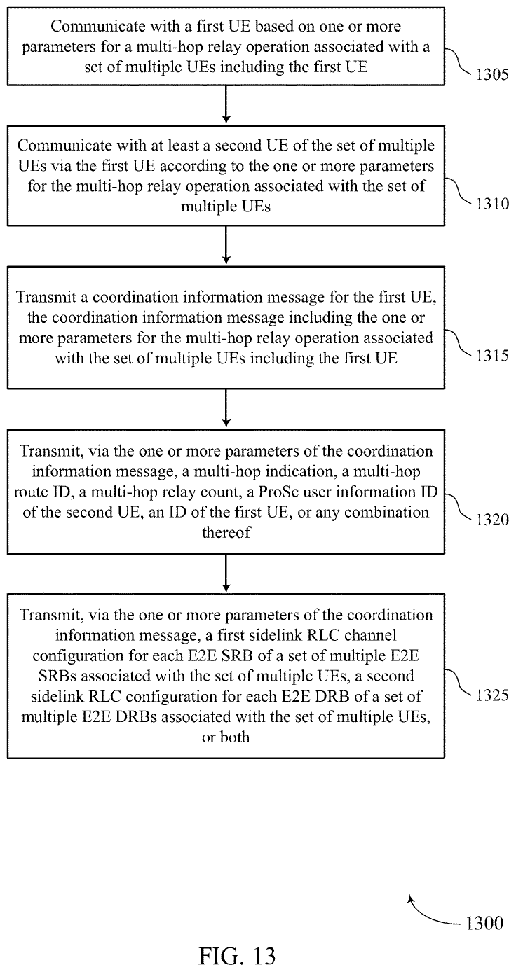

FIG. 13 shows a flowchart illustrating a method 1300 that supports network coordination for multi-hop relays in accordance with aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the wireless network entity to perform the described functions. Additionally, or alternatively, the wireless network entity may perform aspects of the described functions using special-purpose hardware.

At 1305, the method may include communicating with a first UE based on one or more parameters for a multi-hop relay operation associated with a set of multiple UEs including the first UE. The operations of 1305 may be performed in accordance with examples as disclosed herein. In some examples, aspects of the operations of 1305 may be performed by a relay communication component 730 as described with reference to FIG. 7.

At 1310, the method may include communicating with at least a second UE of the set of multiple UEs via the first UE according to the one or more parameters for the multi-hop relay operation associated with the set of multiple UEs. The operations of 1310 may be performed in accordance with examples as disclosed herein. In some examples, aspects of the operations of 1310 may be performed by a relay communication component 730 as described with reference to FIG. 7.

At 1315, the method may include transmitting a coordination information message for the first UE, the coordination information message including the one or more parameters for the multi-hop relay operation associated with the set of multiple UEs including the first UE. The operations of 1315 may be performed in accordance with examples as disclosed herein. In some examples, aspects of the operations of 1315 may be performed by a coordination information transmitting component 735 as described with reference to FIG. 7.

At 1320, the method may include transmitting, via the one or more parameters of the coordination information message, a multi-hop indication, a multi-hop route ID, a multi-hop relay count, a ProSe user information ID of the second UE, an ID of the first UE, or any combination thereof. The operations of 1320 may be performed in accordance with examples as disclosed herein. In some examples, aspects of the operations of 1320 may be performed by a coordination information transmitting component 735 as described with reference to FIG. 7.

At 1325, the method may include transmitting, via the one or more parameters of the coordination information message, a first sidelink RLC channel configuration for each E2E SRB of a set of multiple E2E SRBs associated with the set of multiple UEs, a second sidelink RLC channel configuration for each E2E DRB of a set of multiple E2E DRBs associated with the set of multiple UEs, or both. The operations of 1325 may be performed in accordance with examples as disclosed herein. In some examples, aspects of the operations of 1325 may be performed by a coordination information transmitting component 735 as described with reference to FIG. 7.

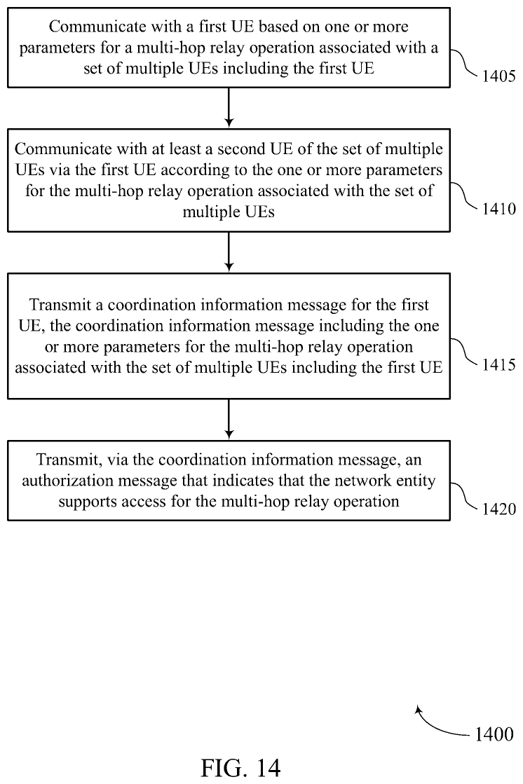

FIG. 14 shows a flowchart illustrating a method 1400 that supports network coordination for multi-hop relays in accordance with aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the wireless network entity to perform the described functions. Additionally, or alternatively, the wireless network entity may perform aspects of the described functions using special-purpose hardware.

At 1405, the method may include communicating with a first UE based on one or more parameters for a multi-hop relay operation associated with a set of multiple UEs including the first UE. The operations of 1405 may be performed in accordance with examples as disclosed herein. In some examples, aspects of the operations of 1405 may be performed by a relay communication component 730 as described with reference to FIG. 7.

At 1410, the method may include communicating with at least a second UE of the set of multiple UEs via the first UE according to the one or more parameters for the multi-hop relay operation associated with the set of multiple UEs. The operations of 1410 may be performed in accordance with examples as disclosed herein. In some examples, aspects of the operations of 1410 may be performed by a relay communication component 730 as described with reference to FIG. 7.

At 1415, the method may include transmitting a coordination information message for the first UE, the coordination information message including the one or more parameters for the multi-hop relay operation associated with the set of multiple UEs including the first UE. The operations of 1415 may be performed in accordance with examples as disclosed herein. In some examples, aspects of the operations of 1415 may be performed by a coordination information transmitting component 735 as described with reference to FIG. 7.

At 1420, the method may include transmitting, via the coordination information message, an authorization message that indicates that the network entity supports access for the multi-hop relay operation. The operations of 1420 may be performed in accordance with examples as disclosed herein. In some examples, aspects of the operations of 1420 may be performed by a coordination information transmitting component 735 as described with reference to FIG. 7.

The following provides an overview of aspects of the present disclosure:

Aspect 1: A method for wireless communications at a network entity comprising: receiving a coordination information message for a first UE, the coordination information message comprising one or more parameters for a multi-hop relay operation associated with a plurality of UEs comprising the first UE; communicating with the first UE based at least in part on receiving the coordination information message; and communicating with at least a second UE of the plurality of UEs via the first UE according to the multi-hop relay operation and the coordination information message.

Aspect 2: The method of aspect 1, further comprising: receiving, via the one or more parameters of the coordination information message, a multi-hop indication, a multi-hop route identifier, a multi-hop relay count, or any combination thereof.

Aspect 3: The method of any of aspects 1 through 2, further comprising: receiving, via the one or more parameters of the coordination information message, a proximity service user information identifier of the second UE, an identifier of the first UE, or any combination thereof.

Aspect 4: The method of any of aspects 1 through 3, further comprising: receiving, via the one or more parameters of the coordination information message, a first sidelink radio link control channel configuration for each end-to-end signal radio bearer of a plurality of end-to-end signal radio bearers associated with the plurality of UEs, a second sidelink radio link control channel configuration for each end-to-end data radio bearer of a plurality of end-to-end data radio bearers associated with the plurality of UEs, or both.

Aspect 5: The method of aspect 4, further comprising: signaling an indication of the first sidelink radio link control channel configuration, the second sidelink radio link control channel configuration, or both as part of a UE context setup procedure or a UE context modification procedure.

Aspect 6: The method of any of aspects 1 through 5, further comprising: receiving the coordination information message via a backhaul signaling message during a handover procedure between the network entity and another network entity.

Aspect 7: The method of any of aspects 1 through 6, further comprising: receiving the coordination information message via a backhaul signaling message during a UE context retrieval procedure, a UE context setup procedure, a UE context modification procedure, or any combination thereof.

Aspect 8: The method of any of aspects 1 through 7, further comprising: receiving, via the coordination information message, an authorization message that indicates that another network entity supports access for the multi-hop relay operation.

Aspect 9: The method of aspect 8, wherein the authorization message corresponds to a layer two relay authorization, a layer three relay authorization, a UE-to-network relay authorization, and a UE-to-UE authorization.

Aspect 10: The method of aspect 8, wherein the authorization message comprises a first authorization for a layer two relay authorization, a second authorization for a layer three relay authorization, a third authorization comprising a UE-to-network relay authorization, a fourth authorization comprising a UE-to-UE authorization, or any combination thereof.

Aspect 11: The method of any of aspects 1 through 10, wherein receiving the coordination information message comprises: receiving the coordination information message from another network entity, wherein the network entity comprises a distributed unit network entity and the other network entity comprises a central unit network entity.

Aspect 12: A method for wireless communications at a network entity comprising: communicating with a first UE based at least in part on one or more parameters for a multi-hop relay operation associated with a plurality of UEs comprising the first UE; communicating with at least a second UE of the plurality of UEs via the first UE according to the one or more parameters for the multi-hop relay operation associated with the plurality of UEs; and transmitting a coordination information message for the first UE, the coordination information message comprising the one or more parameters for the multi-hop relay operation associated with the plurality of UEs comprising the first UE.

Aspect 13: The method of aspect 12, further comprising: transmitting, via the one or more parameters of the coordination information message, a multi-hop indication, a multi-hop route identifier, a multi-hop relay count, or any combination thereof.

Aspect 14: The method of any of aspects 12 through 13, further comprising: transmitting, via the one or more parameters of the coordination information message, a proximity service user information identifier of the second UE, an identifier of the first UE, or any combination thereof.

Aspect 15: The method of any of aspects 12 through 14, further comprising: transmitting, via the one or more parameters of the coordination information message, a first sidelink radio link control channel configuration for each end-to-end signal radio bearer of a plurality of end-to-end signal radio bearers associated with the plurality of UEs, a second sidelink radio link control channel configuration for each end-to-end data radio bearer of a plurality of end-to-end data radio bearers associated with the plurality of UEs, or both.

Aspect 16: The method of aspect 15, further comprising: signaling an indication of the first sidelink radio link control channel configuration, the second sidelink radio link control channel configuration, or both as part of a UE context setup procedure or a UE context modification procedure.

Aspect 17: The method of any of aspects 12 through 16, further comprising: transmitting the coordination information message via a backhaul signaling message during a handover procedure between the network entity and another network entity.

Aspect 18: The method of any of aspects 12 through 17, further comprising: transmitting the coordination information message via a backhaul signaling message during a UE context retrieval procedure, a UE context setup procedure, a UE context modification procedure, or any combination thereof.

Aspect 19: The method of any of aspects 12 through 18, further comprising: receiving, from another network entity, an authorization message that indicates that the network entity is authorized to allow access for the multi-hop relay operation, wherein communicating with the second UE according to the one or more parameters for the multi-hop relay operation is based at least in part on the authorization message; and transmitting, via the coordination information message, the authorization message.

Aspect 20: The method of any of aspects 12 through 19, further comprising: transmitting, via the coordination information message, an authorization message that indicates that the network entity supports access for the multi-hop relay operation.

Aspect 21: The method of aspect 20, wherein the authorization message corresponds to a layer two relay authorization, a layer three relay authorization, a UE-to-network relay authorization, and a UE-to-UE authorization.

Aspect 22: The method of aspect 20, wherein the authorization message comprises a first authorization for a layer two relay authorization, a second authorization for a layer three relay authorization, a third authorization comprising a UE-to-network relay authorization, a fourth authorization comprising a UE-to-UE authorization, or any combination thereof.

Aspect 23: The method of any of aspects 12 through 22, wherein transmitting the coordination information message comprises: transmitting the coordination information message to another network entity, wherein the other network entity comprises a distributed unit network entity and the network entity comprises a central unit network entity.

Aspect 24: An apparatus comprising a processor; memory coupled with the processor; and instructions stored in the memory and executable by the processor to cause the apparatus to perform a method of any of aspects 1 through 11.

Aspect 25: An apparatus comprising at least one means for performing a method of any of aspects 1 through 11.

Aspect 26: A non-transitory computer-readable medium storing code the code comprising instructions executable by a processor to perform a method of any of aspects 1 through 11.

Aspect 27: An apparatus comprising a processor; memory coupled with the processor; and instructions stored in the memory and executable by the processor to cause the apparatus to perform a method of any of aspects 12 through 23.

Aspect 28: An apparatus comprising at least one means for performing a method of any of aspects 12 through 23.

Aspect 29: A non-transitory computer-readable medium storing code the code comprising instructions executable by a processor to perform a method of any of aspects 12 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.” to support this interpretation.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a network entity, comprising:
a processor;
memory coupled with the processor; and
instructions stored in the memory and executable by the processor to cause the apparatus to:
receive a coordination information message for a first user equipment (UE), the coordination information message comprising one or more parameters for a multi-hop relay operation associated with a plurality of UEs comprising the first UE;
communicate with the first UE based at least in part on receiving the coordination information message; and
communicate with at least a second UE of the plurality of UEs via the first UE according to the multi-hop relay operation and the coordination information message.

2. The apparatus of claim 1, wherein the instructions are further executable by the processor to cause the apparatus to:
receive, via the one or more parameters of the coordination information message, a multi-hop indication, a multi-hop route identifier, a multi-hop relay count, or any combination thereof.

3. The apparatus of claim 1, wherein the instructions are further executable by the processor to cause the apparatus to:
receive, via the one or more parameters of the coordination information message, a proximity service user information identifier of the second UE, an identifier of the first UE, or any combination thereof.

4. The apparatus of claim 1, wherein the instructions are further executable by the processor to cause the apparatus to:
receive, via the one or more parameters of the coordination information message, a first sidelink radio link control channel configuration for each end-to-end signal radio bearer of a plurality of end-to-end signal radio bearers associated with the plurality of UEs, a second sidelink radio link control channel configuration for each end-to-end data radio bearer of a plurality of end-to-end data radio bearers associated with the plurality of UEs, or both.

5. The apparatus of claim 4, wherein the instructions are further executable by the processor to cause the apparatus to:
signal an indication of the first sidelink radio link control channel configuration, the second sidelink radio link control channel configuration, or both as part of a UE context setup procedure or a UE context modification procedure.

6. The apparatus of claim 1, wherein the instructions are further executable by the processor to cause the apparatus to:
receive the coordination information message via a backhaul signaling message during a handover procedure between the network entity and another network entity.

7. The apparatus of claim 1, wherein the instructions are further executable by the processor to cause the apparatus to:
receive the coordination information message via a backhaul signaling message during a UE context retrieval procedure, a UE context setup procedure, a UE context modification procedure, or any combination thereof.

8. The apparatus of claim 1, wherein the instructions are further executable by the processor to cause the apparatus to:
receive, via the coordination information message, an authorization message that indicates that another network entity supports access for the multi-hop relay operation.

9. The apparatus of claim 8, wherein the authorization message corresponds to a layer two relay authorization, a layer three relay authorization, a UE-to-network relay authorization, and a UE-to-UE authorization.

10. The apparatus of claim 8, wherein the authorization message comprises a first authorization for a layer two relay authorization, a second authorization for a layer three relay authorization, a third authorization comprising a UE-to-network relay authorization, a fourth authorization comprising a UE-to-UE authorization, or any combination thereof.

11. The apparatus of claim 1, wherein the instructions to receive the coordination information message are executable by the processor to cause the apparatus to:
receive the coordination information message from another network entity, wherein the network entity comprises a distributed unit network entity and the other network entity comprises a central unit network entity.

12. An apparatus for wireless communication at a network entity, comprising:
a processor;
memory coupled with the processor; and
instructions stored in the memory and executable by the processor to cause the apparatus to:
communicate with a first user equipment (UE) based at least in part on one or more parameters for a multi-hop relay operation associated with a plurality of UEs comprising the first UE;
communicate with at least a second UE of the plurality of UEs via the first UE according to the one or more parameters for the multi-hop relay operation associated with the plurality of UEs; and
transmit a coordination information message for the first UE, the coordination information message comprising the one or more parameters for the multi-hop relay operation associated with the plurality of UEs comprising the first UE.

13. The apparatus of claim 12, wherein the instructions are further executable by the processor to cause the apparatus to:
transmit, via the one or more parameters of the coordination information message, a multi-hop indication, a multi-hop route identifier, a multi-hop relay count, or any combination thereof.

14. The apparatus of claim 12, wherein the instructions are further executable by the processor to cause the apparatus to:
transmit, via the one or more parameters of the coordination information message, a proximity service user information identifier of the second UE, an identifier of the first UE, or any combination thereof.

15. The apparatus of claim 12, wherein the instructions are further executable by the processor to cause the apparatus to:
transmit, via the one or more parameters of the coordination information message, a first sidelink radio link control channel configuration for each end-to-end signal radio bearer of a plurality of end-to-end signal radio bearers associated with the plurality ofUEs, a second sidelink radio link control channel configuration for each end-to-end data radio bearer of a plurality of end-to-end data radio bearers associated with the plurality of UEs, or both.

16. The apparatus of claim 15, wherein the instructions are further executable by the processor to cause the apparatus to:
signal an indication of the first sidelink radio link control channel configuration, the second sidelink radio link control channel configuration, or both as part of a UE context setup procedure or a UE context modification procedure.

17. The apparatus of claim 12, wherein the instructions are further executable by the processor to cause the apparatus to:
transmit the coordination information message via a backhaul signaling message during a handover procedure between the network entity and another network entity.

18. The apparatus of claim 12, wherein the instructions are further executable by the processor to cause the apparatus to:
transmit the coordination information message via a backhaul signaling message during a UE context retrieval procedure, a UE context setup procedure, a UE context modification procedure, or any combination thereof.

19. The apparatus of claim 12, wherein the instructions are further executable by the processor to cause the apparatus to:
receive, from another network entity, an authorization message that indicates that the network entity is authorized to allow access for the multi-hop relay operation, wherein communicating with the second UE according to the one or more parameters for the multi-hop relay operation is based at least in part on the authorization message; and
transmit, via the coordination information message, the authorization message.

20-23. (canceled)

24. A method for wireless communications at a network entity comprising:
receiving a coordination information message for a first user equipment (UE), the coordination information message comprising one or more parameters for a multi-hop relay operation associated with a plurality of UEs comprising the first UE;
communicating with the first UE based at least in part on receiving the coordination information message; and
communicating with at least a second UE of the plurality of UEs via the first UE according to the multi-hop relay operation and the coordination information message.

25-30. (canceled)
